(19) United States
(12) Patent Application Publication
(10) Pub. No.: US 2008/0172712 A1
(43) Pub. Date: Jul. 17, 2008

(54) MULTIMEDIA DATA TRANSMITTING APPARATUS, MULTIMEDIA DATA RECEIVING APPARATUS, MULTIMEDIA DATA TRANSMITTING METHOD, AND MULTIMEDIA DATA RECEIVING METHOD

(75) Inventor: Toshihiko MUNETSUGU, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/972,216

(22) Filed: Jan. 10, 2008

Related U.S. Application Data
(60) Provisional application No. 60/884,460, filed on Jan. 11, 2007.

(51) Int. Cl. H04N 7/173

(52) U.S. Cl. 725/118

(57) ABSTRACT

The multimedia data transmitting apparatus according to the present invention includes: a message receiving unit which receives a request message including a transmission start requested position and a transmission end requested position; a transmission position adjustment unit which performs at least one of a first adjustment process of adjusting the transmission start position to a boundary of a unit of encryption immediately ahead of the transmission start requested position or to a position ahead of the boundary, and a second adjustment process of adjusting the transmission end position to a boundary of a unit of encryption immediately behind the transmission end requested position or to a position behind the boundary; a data transmitting unit which transmits, to a terminal, multimedia data from the adjusted transmission start position up to the adjusted transmission end position, and first information indicating the transmission start requested position and the transmission end requested position within the multimedia data.

### BACKGROUND OF THE INVENTION

(1) Field of the Invention

The present invention relates to the transmission and reception of digitalized multimedia content data on a network such as a home network.

(2) Description of the Related Art

In recent years, digital broadcasting such as BS digital broadcasting, CS 110-degree digital broadcasting, and digital terrestrial broadcasting has commenced. Furthermore, DVR for recording a TV-program in a recording medium for digital data such as a Hard Disk Drive (HDD), a Blu-Ray Disc (BD), and a Digital Versatile Disc (DVD) is becoming popular. With this, digitalized multimedia content that can be used in households is increasing.

Meanwhile, with the development of the broadband environment, internet access from households is becoming widespread. Accordingly, the spread of the so-called home network, in which the respective rooms in a house are connected by an IP network, is also advancing.

With such a situation, digital broadcasts received by a digital broadcast receiver in the house, or digital contents stored in a recorder can now be viewed at other rooms, using the home network.

With regard to such sharing of digital content using a home network, there is a move to make this possible not only between the above-mentioned CE devices, but also between all devices connected to a home network, including personal computers (PC) and Personal Digital Assistants (PDA). To be more specific, standardization organizations such as the Digital Living Network Alliance (DLNA) have laid-out and made public standards and implementing guidelines for this purpose.

In such content sharing, the method defined in the Universal Plug and Play AV (UPnP AV) Architecture is widely used in the mutual recognition of the devices and the exchange of information on the contents that can be used, between a server (for example, a set top box or DVR which receives digital broadcasts) and a client (for example, a personal computer or a digital player) in the home network. In UPnP AV, upon receiving an inquiry from the client, the server replies with a list of provided contents and the attributes of each of the contents. Furthermore, as a required protocol for communicating content data, Hypertext Transfer Protocol (HTTP) is used in DLNA. In such content sharing in a home network, contents, such as broadcast contents, which require protection of copyrights and the like, need to be encrypted in transmitting and receiving and, even in the storing in a DVR, such contents must be encrypted then stored.

Here, when multimedia data stored in the DVR is transmitted to the network, assuming that the data which is encrypted at the time of storing is once decrypted and the decrypted data is encrypted again, there will be multimedia data existing in a decrypted state during that period, and there is a danger that they may be stolen. For this reason, it is preferable that the multimedia data is encrypted with an encryption method of sufficient strength at the time of storing, and that the multimedia data is transmitted and received, as is, in its encrypted state.

Here, in the encryption of data, encryption is performed in units of data known as encryption blocks. For example, in the encryption method known as the Advanced Encryption Standard (AES), encryption is performed with 16 bytes as one unit.

Furthermore, in the playback of multimedia data stored once in the DVR, there is a demand for the performance of trick play such as fast-forward and reverse, even in playback via a network. Such trick play is implemented by continuously reproducing parts of the multimedia data which are spaced at certain intervals. For this reason, with respect to the server, the reproduction terminal repeats the obtainment of data that designates position.

### SUMMARY OF THE INVENTION

However, there exists the problem that the boundary of the smallest unit for the random access required in trick play and the boundary of the encryption block do not always match. The format used in the storage in a DVR and the like is also stored as the collection of specific units of data. For example, the generally used MPEG2-TS is a collection of 188-byte TS packets. In addition, the smallest unit for the random access required in trick play is called Group of Picture (GOP), and is made up of plural TS packets. In this case, since 188 is not a multiple of 16, when multimedia data in the MPEG2-TS format is encrypted using AES, there is a place where the boundary of the TS packets and the boundary of the encryption blocks do not match. As such, when the boundary of the TS packet is designated and data is obtained for trick play, the cryptography cannot be decrypted and trick play cannot be performed.

In view of this, the present invention has as an object to provide a multimedia data transmitting apparatus which can transmit multimedia data of which cryptography can always be decrypted by the terminal, as well as a multimedia data receiving apparatus which receives the multimedia data.

In order to solve the conventional problem, the multimedia data transmission apparatus in the present invention is a multimedia data transmitting apparatus which stores encrypted multimedia data representing at least one of video and audio, and transmits the encrypted multimedia data to a terminal, via a network, in response to a request from the terminal, the multimedia data transmitting apparatus including: a message receiving unit which receives a request message from the terminal, the request message being a message requesting transmission of multimedia data and including a transmission start requested position and a transmission end requested position; a transmission position adjustment unit which performs at least one of: a first adjustment process of adjusting a transmission start position to a boundary of a unit of encryption immediately ahead of the transmission start requested position or to a position ahead of the boundary, in the case where the transmission start requested position does not match a boundary of the unit of encryption of the multimedia data; and a second adjustment process of adjusting a transmission end position to a boundary of the unit of encryption immediately behind the transmission end requested position or to a position behind the boundary, in the case where the transmission end requested position does not match a boundary of the unit of encryption of the multimedia data; and a data transmitting unit which transmits to the terminal: the multimedia data, from the adjusted transmission start position in the case where the first adjustment process is performed or the transmission start requested position in the case where the first adjustment process is not performed, up to the adjusted transmission end position in the case where the second adjustment process is performed or the transmission end requested position in the case where the second adjustment process is not performed; and first information indicating the transmission start requested position and the transmission end requested position within the multimedia data.

According to this configuration, since transmitted multimedia data can always be decrypted, and it is possible to recognize, within the transmitted data, the range of data required by the terminal, the desired reproduction becomes possible.

Furthermore, it is also possible that the request message further includes request information indicating whether or not the terminal is requesting the multimedia data transmitting apparatus for position adjustment, and the transmission position adjustment unit performs at least one of the first adjustment process and the second adjustment process in the case where the request information indicates that position adjustment is requested.

According to this configuration, by creating an encryption block by connecting with data previously received by the terminal, and performing decryption, or by configuring a unit of data needed in reproduction, overlapping data transmission can be prevented and communication efficiency can be improved.

Furthermore, it is also possible that the multimedia data transmitting apparatus, further includes an application execution unit executes an application program, wherein the transmission position adjustment unit performs at least one of the first adjustment process and the second adjustment process, in accordance with a condition received from the application program.

According to this configuration, there is the effect that in respective control such as in the case where the encryption method changes for each multimedia data, or the case of an encryption method which includes a non-fixed-length encryption block, or the case where whether or not to perform adjustment is determined according to a partner-terminal, and so on, such control can be controlled by the application program.

Furthermore, it is also possible that the multimedia data transmitting apparatus, further includes a broadcast signal receiving unit receives a broadcast signal including the multimedia data and the application program.

Furthermore, the multimedia data receiving apparatus in the present invention is a multimedia data receiving apparatus which receives encrypted multimedia data from the multimedia data transmitting apparatus via a network, the multimedia data receiving apparatus including: a request message generation unit which generates a request message which is a message requesting transmission of multimedia data, the request message including request information, a transmission start requested position which is a transmission start position of the multimedia data, and a transmission end requested position which is a transmission end position of the multimedia data; a transmitting and receiving unit which transmits the request message to the multimedia data transmitting apparatus, and receives, from the multimedia data transmitting apparatus, the multimedia data and first information which indicates the transmission start requested position and the transmission end requested position within the multimedia data; a decryption unit which decrypts the multimedia data received by the transmitting and receiving unit; a data processing unit which extracts multimedia data from the transmission start requested position up to the transmission end requested position indicated in the first information, from the multimedia data decrypted by the decryption unit; and a reproduction unit which reproduces the multimedia data extracted by the data processing unit, wherein the request information is information indicating whether or not at least one of a first adjustment process and a second adjustment process is requested to the multimedia data transmitting apparatus, the first adjustment process adjusting the transmission start position to a boundary of a unit of encryption immediately ahead of the transmission start requested position or to a position ahead of the boundary, in the case where the transmission start requested position does not match a boundary of the unit of encryption of the multimedia data, the second adjustment process adjusting the transmission end position to a boundary of the unit of encryption immediately behind the transmission end requested position or to a position behind the boundary, in the case where the transmission end requested position does not match a boundary of the unit of encryption of the multimedia data.

According to this configuration, there is the effect in which, even in the case where the position of data needed in trick play and the boundaries of an encryption block do not match, it is possible to receive a unit of data that can be decrypted and properly obtain reproduction data.

Furthermore, it is also possible that the multimedia data receiving apparatus further includes an application execution unit which executes one or more application programs, wherein at least one of information identifying the multimedia data transmitting apparatus and an identifier of the multimedia data are received from a certain application program from among the one or more application programs.

According to this configuration, the application program can specify the server and the content to be reproduced.

Furthermore, it is also possible that the request message generation unit generates the request information in accordance with a condition provided by a certain application program from among the one or more application programs.

According to this configuration, there is the effect of enabling the handling of received data to be controlled by the application program.

Furthermore, it is also possible that the one or more application programs are imported via a broadcast signal.

Furthermore, the multimedia data transmitting method in the present invention is a multimedia data transmitting method used in a multimedia data transmitting apparatus which stores encrypted multimedia data representing at least one of video and audio, and transmits the encrypted multimedia data to a terminal, via a network, in response to a request from the terminal, the multimedia data transmitting method including: a message receiving step of receiving a request message from the terminal, the request message being a message requesting transmission of multimedia data and including a transmission start requested position and a transmission end requested position; a transmission position adjustment step of performing at least one of: a first adjustment process of adjusting a transmission start position to a boundary of a unit of encryption immediately ahead of the transmission start requested position or to a position ahead of the boundary, in the case where the transmission start requested position does not match a boundary of the unit of encryption of the multimedia data; and a second adjustment process of adjusting a transmission end position to a boundary of the unit of encryption immediately behind the transmission end requested position or to a position behind the boundary, in the case where the transmission end requested position does not match a boundary of the unit of encryption of the multimedia data; and a data transmitting step of transmitting to the terminal: the multimedia data, from the adjusted transmission start position in the case where the first adjustment process is performed or the transmission start requested position in the case where the first adjustment process is not performed, up to the adjusted transmission end position in the case where the second adjustment process is performed or the transmission end requested position in the case where the second adjustment process is not performed; and first information indicating the transmission start requested position and the transmission end requested position within the multimedia data.

According to this configuration, since transmitted multimedia data can always be decrypted, and it is possible to recognize, within the transmitted data, the range of data required by the terminal, the desired reproduction becomes possible.

Furthermore, the multimedia data receiving method in the present invention is a multimedia data receiving method used in a multimedia data receiving apparatus which receives encrypted multimedia data from a server via a network, the multimedia data receiving method including: a request message generation step of generating a request message which is a message requesting transmission of multimedia data, the request message including request information, a transmission start requested position which is a transmission start position, and a transmission end requested position which is a transmission end position; a transmission step of transmitting the request message to the server; a receiving step of receiving, from the server, the multimedia data and first information which indicates the transmission start requested position and the transmission end requested position within the multimedia data; a decryption step of decrypting the received multimedia data; a data processing step of extracting multimedia from the transmission start requested position up to the transmission end requested position indicated in the first information, from the decrypted multimedia data; and a reproduction step of reproducing the extracted multimedia data, wherein the request information is information indicating whether or not at least one of a first adjustment process and a second adjustment process is requested to the server, the first adjustment process adjusting the transmission start position to a boundary of a unit of encryption immediately ahead of the transmission start requested position or to a position ahead of the boundary, in the case where the transmission start requested position does not match a boundary of the unit of encryption of the multimedia data, the second adjustment process adjusting the transmission end position to a boundary of the unit of encryption immediately behind the transmission end requested position or to a position behind the boundary, in the case where the transmission end requested position does not match a boundary of the unit of encryption of the multimedia data.

According to this configuration, there is the effect in which, even in the case where the position of data needed in trick play and the boundaries of an encryption block do not match, it is possible to receive a unit of data that can be decrypted, and properly obtain reproduction data.

Furthermore, the program for a multimedia data transmitting method in the present invention is a program for a multimedia data transmitting method used in a multimedia data transmitting apparatus which stores encrypted multimedia data representing at least one of video and audio, and transmits the encrypted multimedia data to a terminal, via a network, in response to a request from the terminal, the program causing the computer to execute: a message receiving step of receiving a request message from the terminal, the request message being a message requesting transmission of multimedia data and including a transmission start requested position and a transmission end requested position; a transmission position adjustment step of performing at least one of: a first adjustment process of adjusting a transmission start position to a boundary of a unit of encryption immediately ahead of the transmission start requested position or to a position ahead of the boundary, in the case where the transmission start requested position does not match a boundary of the unit of encryption of the multimedia data; and a second adjustment process of adjusting a transmission end position to a boundary of the unit of encryption immediately behind the transmission end requested position or to a position behind the boundary, in the case where the transmission end requested position does not match a boundary of the unit of encryption of the multimedia data; and a data transmitting step of transmitting to the terminal: the multimedia data, from the adjusted transmission start position in the case where the first adjustment process is performed or the transmission start requested position in the case where the first adjustment process is not performed, up to the adjusted transmission end position in the case where the second adjustment process is performed or the transmission end requested position in the case where the second adjustment process is not performed; and first information indicating the transmission start requested position and the transmission end requested position within the multimedia data.

Furthermore, the program for a multimedia data receiving method is a program for a multimedia data receiving method used in a multimedia data receiving apparatus which receives encrypted multimedia data from a server via a network, the program including: a request message generation step of generating a request message which is a message requesting transmission of multimedia data, the request message including request information, a transmission start requested position which is a transmission start position, and a transmission end requested position which is a transmission end position; a transmission step of transmitting the request message to the server; a receiving step of receiving, from the server, the multimedia data and first information which indicates the transmission start requested position and the transmission end requested position within the multimedia data; a decryption step of decrypting the received multimedia data; a data processing step of extracting multimedia from the transmission start requested position up to the transmission end requested position indicated in the first information, from the decrypted multimedia data; and a reproduction step of reproducing the extracted multimedia data, wherein the request information is information indicating whether or not at least one of a first adjustment process and a second adjustment process is requested to the server, the first adjustment process adjusting the transmission start position to a boundary of a unit of encryption immediately ahead of the transmission start requested position or to a position ahead of the boundary, in the case where the transmission start requested position does not match a boundary of the unit of encryption of the multimedia data, the second adjustment process adjusting the transmission end position to a boundary of the unit of encryption immediately behind the transmission end requested position or to a position behind the boundary, in the case where the transmission end requested position does not match a boundary of the unit of encryption of the multimedia data.

As described above, according to the multimedia data transmitting apparatus and the multimedia data receiving apparatus of the present invention, there is the effect that, in multimedia data transmission and reception through a network such as a home network, even when data is in the encrypted state, data desired by a reproduction terminal can be appropriately communicated, and trick play can be performed with the content in a protected state.

As further information about the technical background to this application, the disclosure of U.S. Provisional Application No. 60/884,460 filed Jan. 11, 2007, including specification, drawings and claims, is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram for the multimedia content communication system in the embodiment of the present invention;

FIG. 2 is a block diagram showing an outline of the functional configuration of the multimedia data transmitting apparatus 101 in the embodiment of the present invention;

FIG. 3 is a diagram for describing the operation of the transmission position adjustment unit 4005 in the embodiment of the present invention;

FIG. 4 is a block diagram showing an outline of the functional configuration of the multimedia data receiving apparatus 102 in the embodiment of the present invention;

FIG. 5 is a diagram showing the flow of the processing by the multimedia data transmitting apparatus 101 and the multimedia data receiving apparatus 102 in the embodiment of the present invention;

FIG. 6 is a configuration diagram for the multimedia data transmitting apparatus 101 in the embodiment of the present invention;

FIG. 7 is a diagram showing an example of an external view in the case where the input 201 unit is made up of a front panel;

FIG. 8 is a structure diagram for the program structure stored in the multimedia data transmitting apparatus 101 in the embodiment of the present invention;

FIG. 9A is a diagram showing an example of an on-screen display in the present invention;

FIG. 9B is a diagram showing an example of an on-screen display in the present invention;

FIG. 10 is a diagram showing an example of information stored in the second memory 203 of the present invention;

FIG. 11 is a diagram showing an example of information stored in the second memory 203 of the present invention;

FIG. 12A is a diagram showing an example of information stored in the second memory 203 of the present invention;

FIG. 12B is a diagram showing an example of information stored in the second memory 203 of the present invention;

FIG. 12C is a diagram showing an example of information stored in the second memory 203 of the present invention;

FIG. 13 is a diagram showing an example of information stored in the second memory 203 of the present invention;

FIG. 14 is a diagram showing an example of information stored in the second memory 203 of the present invention;

FIG. 15 is a diagram showing an example of information stored in the second memory 203 of the present invention;

FIG. 16 is a diagram showing an example of information stored in the second memory 203 of the present invention;

FIG. 17 is a diagram showing an example of the structure of data stored in the second memory 203 in the embodiment of the present invention;

FIG. 18 is a diagram showing an example of the attribute information of multimedia data in the embodiment of the present invention;

FIG. 19 is a diagram showing an example of the attribute information table in the embodiment of the present invention;

FIG. 20 is a diagram showing an example of the URI table in the embodiment of the present invention;

FIG. 21 is an internal configuration diagram for the network library 405e;

FIG. 22 is a diagram showing an example of Java API provided in the network library 405e;

FIG. 23 is a diagram showing an example of Java class definition used in the network library 405e;

FIG. 24 is a diagram showing an example of a Java interface definition used in the network library 405e;

FIG. 25 is a diagram showing an example of Java class definition used in the network library 405e;

FIG. 26 is a diagram showing an example of Java API provided in the network library 405e;

FIG. 27 is a diagram showing an example of a Java class definition used in the network library 405e;

FIG. 28 is a diagram showing an example of Java API provided in the network library 405e;

FIG. 29 is a diagram showing an example of Java class definition used in the network library 405e;

FIG. 30 is a diagram showing an example of Java API provided in the network library 405e;

FIG. 31 is a diagram showing an example of Java API provided in the network library 405e;

FIG. 32 is a diagram showing an example of a Java class definition used in the network library 405e;

FIG. 33 is a configuration diagram for the multimedia data receiving apparatus 102 in the embodiment of the present invention;

FIG. 34 is a structure diagram for the program structure stored in the multimedia data receiving apparatus 102 in the embodiment;

FIG. 35 is an internal configuration diagram for the network library 3004d;

FIG. 36 is a diagram showing an example of Java API provided in the network library 3004d;

FIG. 37 is a diagram showing an example of Java class definition used in the network library 3004d;

FIG. 38 is a diagram showing an example of Java class definition used in the network library 3004d;

FIG. 39 is a diagram showing an example of Java class definition used in the network library 3004d;

FIG. 40 is a diagram showing an example of Java API provided in the network library 3004d;

FIG. 41 is a diagram showing an example of Java API provided in the network library 3004d;

FIG. 42 is a diagram showing an example of Java API provided in the network library 3004d;

FIG. 43 is a diagram showing an example of Java API provided in the network library 3004d.

### BEST MODE FOR CARRYING OUT THE INVENTION

Hereinafter, the embodiment of the present invention shall be described with reference to the drawings.

### Embodiment

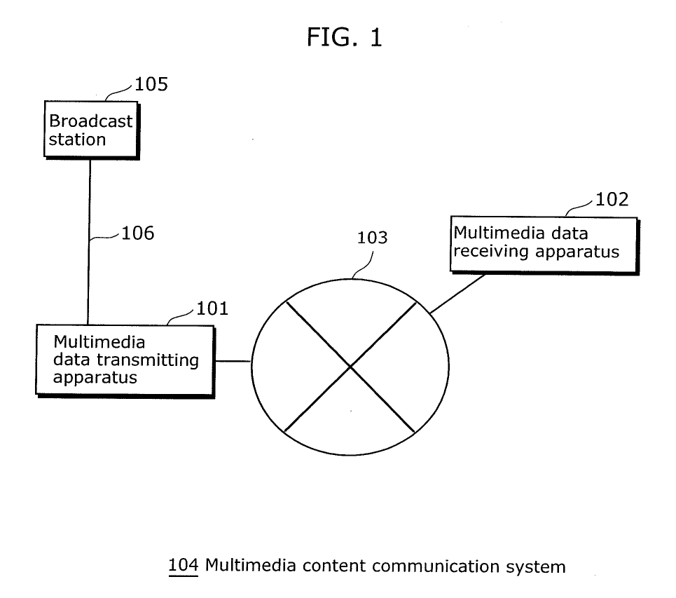

FIG. 1 is a configuration diagram for the multimedia content communication system in the embodiment of the present invention. In FIG. 1, 101 denotes a multimedia data transmitting apparatus in the present invention, 102 denotes a multimedia data receiving apparatus in the present invention, 103 denotes a network, and 104 denotes a multimedia content communication system made up of these elements. The multimedia data transmitting apparatus 101 and the multimedia data receiving apparatus 102 are connected to the network 103, and can communicate with each other via the network 103. In addition, 105 denotes a cable television broadcast station, 106 denotes a cable connecting the multimedia data transmitting apparatus 101 and the broadcast station 105.

The multimedia data transmitting apparatus 101 in the present embodiment is a CATV Set Top Box (STB) which includes a network interface and a storage unit for storing multimedia data. The multimedia data transmitting apparatus 101 is connected to the broadcast station 105 via the cable 106. In addition, the multimedia data transmitting apparatus 101 stores the multimedia data of a digital broadcast content received from the broadcast station 105, in the storage unit. Furthermore, the multimedia data transmitting apparatus 101 is connected to the network 103 via the network interface. In addition, the multimedia data transmitting apparatus 101 receives, through the network 103, requests transmitted from the multimedia data receiving apparatus 102. Subsequently, in accordance with the requests, the multimedia data transmitting apparatus 101 transmits, to the multimedia data receiving apparatus 102, through the network 103, the information and attributes or the multimedia data of the contents of digital broadcasts received, or each of the stored contents.

Moreover, the digital broadcast content stored by the multimedia data transmitting apparatus 101 in the storage unit is data in the MPEG-2-TS format. In addition, the multimedia data transmitting apparatus 101 encrypts the data in the MPEG2-TS format, and stores the encrypted data. It is assumed that the encryption format to be used in the AES. Note that the same effect can be obtained even when another encryption method, such as DES and the like, is used.

The multimedia data receiving apparatus 102 transmits a transmission request for a list of contents that can be provided, to the multimedia data transmitting apparatus 101, according to a user's request. Then, it receives a list of contents from the multimedia data transmitting apparatus 101 as a reply to the request, and presents the list to the user. In addition, the multimedia data receiving apparatus 102 transmits, to the multimedia data transmitting apparatus 101, a transmission request for the multimedia data of a content selected by the user. The multimedia data receiving apparatus 102 receives encrypted multimedia data as a reply to the request, decrypts the cryptography, and presents this to the user by reproduction. In addition, upon receiving a request for trick play such as fast-forward, reverse, and the like, the multimedia data receiving apparatus 102 implements the trick play by stopping the communication of multimedia data temporarily, sequentially issues anew a transmission request for parts necessary in the trick play. Each time, the multimedia data receiving apparatus 102, receives multimedia data, decrypts the cryptography and reproducing the decrypted multimedia data.

The network 103 is a home network established in the household, and is an IP network configured of the Internet, wireless LAN, and so on.

Hereinafter, the outline configuration of multimedia data transmitting apparatus 101 and the multimedia data receiving apparatus 102 shall be described.

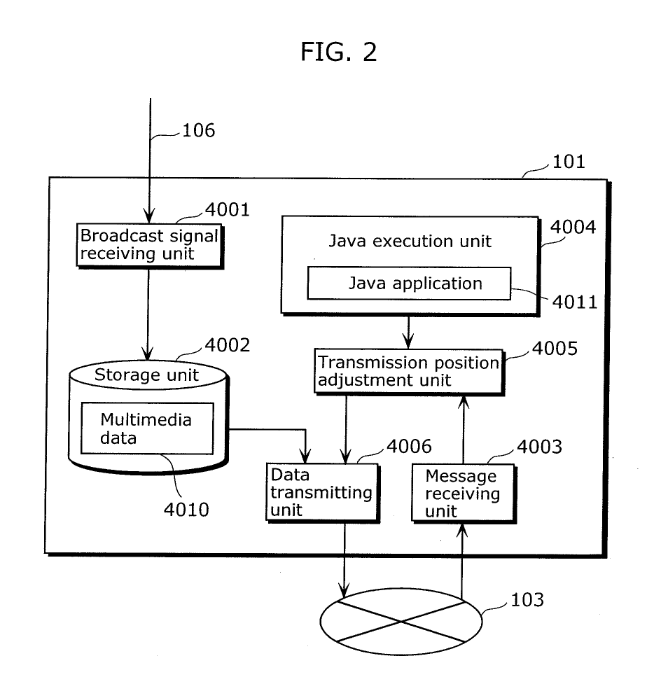

FIG. 2 is a block diagram showing an outline of the functional configuration of the multimedia data transmitting apparatus 101 in the present embodiment

The multimedia data transmitting apparatus 101 stores encrypted multimedia data representing at least one of video or audio. The multimedia data transmitting apparatus 101 transmits, in response to a request from the multimedia data receiving apparatus, encrypted multimedia data to the multimedia data receiving apparatus 102, via the network 103.

The multimedia data transmitting apparatus 101 includes a broadcast signal receiving unit 4001, a storage unit 4002, a message receiving unit 4003, a Java execution unit 4004, a transmission position adjustment unit 4005, and a data transmitting unit 4006.

The broadcast signal receiving unit 4001 receives, via the cable 106, a broadcast signal transmitted by the broadcast station 105. The broadcast signal includes multimedia data and a Java application.

The storage unit 4002 is a storage unit which stores multimedia data 4010 received by the broadcast signal receiving unit 4001.

The Java execution unit 4004 executes a Java application 4011 received by the broadcast signal receiving unit 4001. Note that the Java application 4011 may be obtained from the broadcast station via the Internet.

The message receiving unit 4003 receives a request message transmitted from the multimedia data receiving apparatus 102. The request message is a message with which the multimedia data receiving apparatus 102 requests the multimedia data transmitting apparatus 101 for the transmission of multimedia data. The request message includes a transmission start requested position, a transmission end requested position, and request information. The request message is information indicating whether or not the multimedia data receiving apparatus 102 requests the multimedia data transmitting apparatus 101 to adjust the range of multimedia data to be transmitted by the multimedia data transmitting apparatus 101.

The transmission position adjustment unit 4005 adjusts the transmission start requested position and the transmission end requested position included in the request message, to the boundaries of a unit of encryption of the multimedia data, in the case where adjustment is requested according to the request information included in the request message.

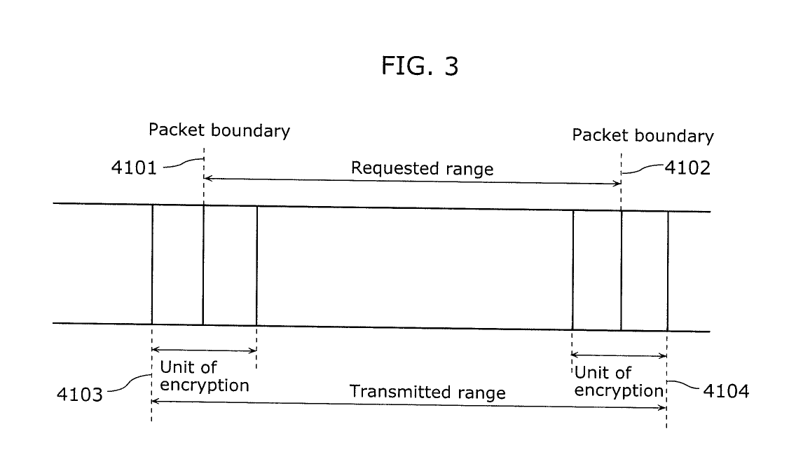

FIG. 3 is a diagram for describing the operation of the transmission position adjustment unit 4005.

As shown in FIG. 3, the transmission position adjustment unit 4005 adjusts the transmission start position and the transmission end position in the case where the packet boundaries designated according to the request message does not match the boundaries of the unit of encryption. More specifically, in the case where a transmission start requested position 4101 included in the request message does not match a unit of encryption boundary, the transmission position adjustment unit 4005 adjusts the transmission start position to a unit of encryption boundary 4103 which immediately precedes the transmission start requested position 4101. Furthermore, in the case where a transmission end requested position 4102 included in the request message does not match a unit of encryption boundary, the transmission position adjustment unit 4005 adjusts the transmission end position to a unit of encryption boundary 4104 which immediately follows the transmission end requested position 4102.

Furthermore, the transmission position adjustment unit 4005 adjusts the transmission start position and the transmission end position in accordance with a condition received from a Java application 4011. For example, information indicating unit of encryption boundaries is passed to the transmission position adjustment unit 4005 from the Java application 4011. The transmission position adjustment unit 4005 adjusts the transmission start position and the transmission end position based on the received information on the unit of encryption boundaries.

The data transmitting unit 4006 transmits the multimedia data from the transmission start position to the transmission end position adjusted by the transmission position adjustment unit 4005, to the multimedia data receiving apparatus 102, via the network 103. Note that in the case where the transmission position adjustment unit 4005 does not perform the adjustment of the transmission start position and the transmission end position, the data transmitting unit 4006 transmits the multimedia data from the transmission start requested position to the transmission end requested position included in the request message.

Furthermore, the data transmitting unit 4006 transmits information indicating the transmission start requested position and the transmission end requested position within the multimedia data, simultaneously with the multimedia data, to the multimedia data receiving apparatus 102.

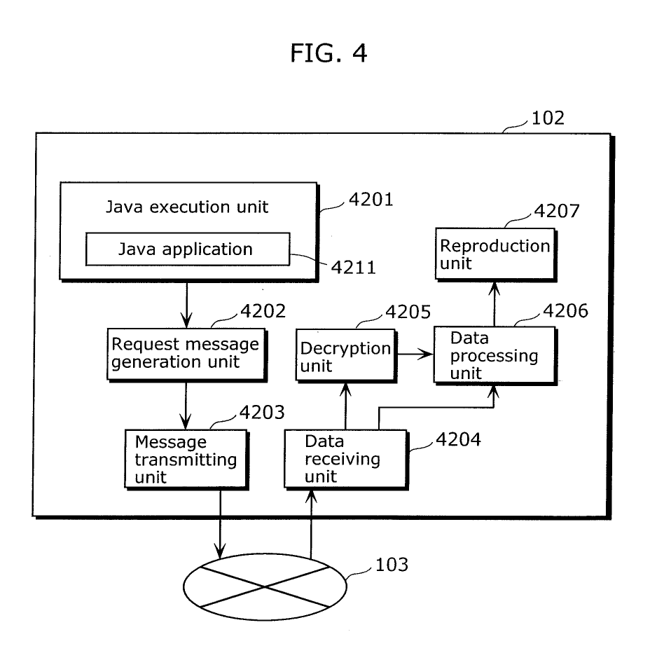

FIG. 4 is a block diagram showing an outline of the functional configuration of the multimedia data receiving apparatus 102 in the present embodiment.

The multimedia data receiving apparatus 102 transmits the request message to the multimedia data transmitting apparatus 101. The multimedia data receiving apparatus 102 receives encrypted multimedia data from the multimedia data transmitting apparatus 101, via a network.

The multimedia data receiving apparatus 102 includes a Java execution unit 4201, a request message generation unit 4202, a message transmitting unit 4203, a data receiving unit 4204, a decryption unit 4205, a data processing unit 4206, and a reproduction unit 4207.

The Java execution unit 4201 executes a Java application 4211. For example, the Java application 4211 is imported to the multimedia data receiving apparatus 102 via a broadcast signal or the Internet. Furthermore, the multimedia data receiving apparatus 102 may obtain the Java application 4211 from the multimedia data transmitting apparatus 101, via the network 103.

Furthermore, the Java application 4211 may pass, to the request message, information identifying the multimedia data transmitting apparatus 101 to be the communication partner, and an identifier of the multimedia data. In other words, the server which is to be the communication partner as well as the type of the multimedia data to be transmitted are controlled by the Java application 4211.

The request message generation unit 4202 generates a request message including the transmission start requested position, the transmission end requested position which is the transmission end position of the multimedia data, and request information. The transmission start requested position and the transmission end requested position are the transmission start position and the transmission end position, respectively, which are requested by the multimedia data receiving apparatus 102.

Furthermore, the request message generation unit 4202 generates the request information in accordance with the condition provided by the Java application 4211. In other words, whether or not position adjustment is to be requested is controlled by the Java application 4211.

The message transmitting unit 4203 transmits the request message generated by the request message generation unit 4202 to the multimedia data transmitting apparatus 101 via the network 103.

The data receiving unit 4202 receives, via the network 103, the multimedia data transmitted by the multimedia data transmitting apparatus 101, as well as the information indicating the transmission start requested position and the transmission end requested position within the multimedia data.

The data receiving unit 4204 passes the received multimedia data to the decryption unit 4205 in units of encryption. The decryption unit 4205 decrypts the cryptography of the received multimedia data.

The data processing unit 4206 refers to the information indicating the transmission start requested position and the transmission end requested position within the multimedia data, received from the data receiving unit 4204, and extracts from among the multimedia data decrypted by the decryption unit 4205, the multimedia data from the transmission start requested position and the transmission end requested position indicated in the information. In other words, the data processing unit 4206 extracts the data within the range requested according to the request message.

The reproduction unit 4207 reproduces the multimedia data extracted by the data processing unit 4206.

Hereinafter, the operation of the multimedia data transmitting apparatus 101 and the multimedia data receiving apparatus 102 shall be described.

First, the outline of the operation of the multimedia data transmitting apparatus 101 and the multimedia data receiving apparatus 102 shall be described.

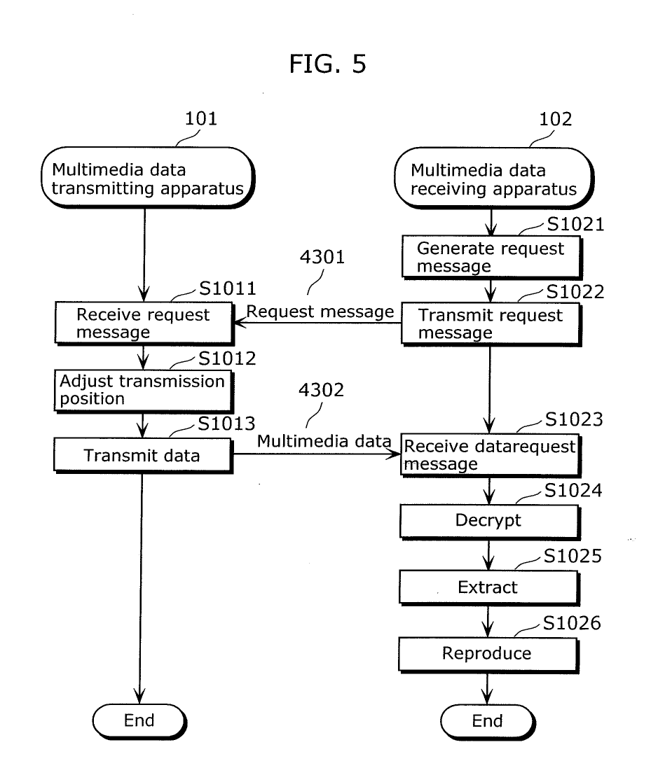

FIG. 5 is a flow diagram showing the flow of the processing by the multimedia data transmitting apparatus 101 and the multimedia data receiving apparatus 102 in the embodiment of the present invention.

First, the request message generation unit 4202 of the multimedia data receiving apparatus 102 generates a request message 4301 (S1021). Next, the message transmitting unit 4203 transmits the request message 4301 generated by the request message generation unit 4202 to the multimedia data transmitting apparatus 101 (S1022).

The message receiving unit 4003 of the multimedia data transmitting apparatus 101 receives the request message 4301 (S1011). Next, the transmission position adjustment unit 4005 adjusts the transmission start requested position and the transmission end requested position included in the request message, to the boundaries of a unit of encryption (S1012). Next, the data transmitting unit 4006 transmits multimedia data 4302 of an adjusted range as well as information indicating the transmission start requested position and the transmission end requested position within the multimedia data, to the multimedia data receiving apparatus 102 (S1013).

The data receiving unit 4204 of the multimedia data receiving apparatus 102 receives the multimedia data 4302 and the information indicating the transmission start requested position and the transmission end requested position within the multimedia data 4302 (S1023). The decryption unit 4205 decrypts the multimedia data 4302 (S1024). The data processing unit 4206 extracts from the decrypted multimedia data, the multimedia data from the transmission start requested position and the transmission end requested position (S1025). The reproduction unit 4207 reproduces the extracted multimedia data (S1026).

Hereinafter the communication and respective operations of the multimedia data transmitting apparatus 101 and the multimedia data receiving apparatus 102 shall be described in detail.

When the multimedia data transmitting apparatus 101 and the multimedia data receiving apparatus 102 are connected to the network 103, they search and discover the devices connected to the network 103, then they acquire the functionalities provided by each of the discovered devices. Since this communication is carried out as defined by the UPnP Device Architecture (DA), in the same manner as with DLNA, detailed description shall be omitted. Through these communications, the multimedia data transmitting apparatus 101 can recognize that the multimedia data receiving apparatus 102 is a player which is connected to the network 103, and which receives multimedia data from the network 103 and reproduces the received multimedia data. Furthermore, the multimedia data receiving apparatus 102 can recognize that the multimedia data transmitting apparatus 101 is a multimedia server which is connected to the network 103.

Hereinafter, the communication of multimedia data between the multimedia data transmitting apparatus 101 and the multimedia data receiving apparatus 102 shall be described in sequence.

First, the multimedia data receiving apparatus 102 transmits a transmission request for a list of contents that can be provided, to the multimedia data transmitting apparatus 101. Then, upon receiving the request, the multimedia data transmitting apparatus 101 retrieves the contents that can be provided, and replies to the multimedia data receiving apparatus 102, with the list. This communication can be carried out using the Browse or Search of the UPnP AV Content Directory Service (CDS), and thus detailed description shall be omitted.

Upon receiving, from the multimedia data receiving apparatus 102, the transmission request for the list of contents that can be provided, to the multimedia data transmitting apparatus 101 replies with a list of contents stored in the storage unit. Since a list defined by the UPnP AV or DLNA can be used for the list to be transmitted, detailed description shall be omitted.

Receiving the provided content list, the multimedia data receiving apparatus 102 presents this list to the user. Then, the multimedia data receiving apparatus 102 requests, to the multimedia data transmitting apparatus 101, the transmission of multimedia data of a content selected by the user. The multimedia data transmitting apparatus 101 reads the requested content data from the storage unit, and transmits this to the multimedia data receiving apparatus 102. In the communication of the multimedia, communication is performed using HTTP which is a mandatory protocol in DLNA. For example, assuming that the Uniform Resource Identifier (URI) of the multimedia data is http://192.168.0.3/AVData/0001.m2ts, an HTTP request such as the example below is issued from the multimedia data receiving apparatus 102 to the multimedia data transmitting apparatus 101.

GET http://192.168.0.3/AVData/0001.m2ts HTTP/1.1

Host: 192.168.0.3

Date: Thr Jan. 11 15:00:00 2007 GMT

User-Agent: AVT Client

Connection: Keep-Alive

At this time, the multimedia data transmitting apparatus 101 transmits, to the multimedia data receiving apparatus 102, encrypted multimedia data, as is, without decrypting the cryptography applied at the time of storing. At this time, an HTTP response such as the example below is transmitted from the multimedia data transmitting apparatus 101 to the multimedia data receiving apparatus 102.

HTTP/1.1 200 OK

Date: Thr Jan. 11 15:00:01 2007 GMT

Server: AVT Server

Connection: Keep-Alive

Content-Type: video/mpeg

Content-Length: 1880000000

(Empty line)

[1880000000-byte data]

The multimedia data receiving apparatus 102 receives the encrypted multimedia data and decrypts its cryptography and, in addition, decodes data encoded according to MPEG2-TS and reproduces the decoded data.

Note that the multimedia data transmitting apparatus 102 receives in advance, from the multimedia data transmitting apparatus 101, an encryption key for decrypting the cryptography of encrypted multimedia data to be received. This is performed using communication protected by Secure Socket Layer (SSL), Transport Layer Security (TLS), or the like. Alternatively, it is also possible to have a configuration in which the encryption key is obtained in the protected state via the broadcast station 105, and the like.

In addition, when trick play is requested by the user, the multimedia data receiving apparatus 102 once stops the on-going reception of multimedia data. This is performed by closing the HTTP session. Alternatively, the stopping of data transmission may be requested to the multimedia data transmitting apparatus 101 using an other session. Next, based on the type of the trick play, the multimedia data receiving apparatus 102 determines the section of the multimedia data necessary therefor, and transmits to the multimedia data transmitting apparatus 101 a transmission request for such section only. A necessary section refers to a GOP, which is the smallest unit for the random access of videos, or an I frame. Trick play is performed by repeating: the determining of the range of necessary data according to the type of the trick play, such as fast-forward, reverse, and slow; and receiving and displaying only such data.

In this case, the multimedia data receiving apparatus 102 designates a transmission start requested position and a transmission end requested position, and requests data transmission to the multimedia data transmitting apparatus 101. However, since it is possible that the transmission start requested position and the transmission end requested position do not coincide with the boundaries of encryption blocks, the multimedia data receiving apparatus 102 requests for the adjustment of the transmission start position and the transmission end position. This is performed by including an extension header X-Range-Adjust to the HTTP request. In the extension header X-Range-Adjust, the transmission request range and the position adjustment request for the transmission start position and the transmission end position are delimited by a semicolon “;”. The designation of the transmission request range is assumed to follow the HTTP Range header. However, it is prohibited to designate a plurality of ranges at the same time. Furthermore, true is designated when requesting position adjustment, and false is designated when not requesting position adjustment. For example, assume that the transmission start requested position is the 47940th byte, with the beginning of the multimedia data as 0; and the transmission request end position is the 95879th byte, with the beginning of the multimedia data as 0. In the case where the adjustment of the transmission start position and the transmission end position is requested, the extension header is as follows.

X-Range-Adjust: bytes=47940-95879 ; true; true

For example, assume that the transmission start requested position is the 48128th byte, with the beginning of the multimedia data as 0, and the transmission end requested position is the 95879th byte, with the beginning of the multimedia data as 0. In the case where the adjustment of the transmission start position is not requested and only the adjustment of the transmission end position is requested, the extension header is as follows.

X-Range-Adjust: bytes=48128-95879; false; true

In the case where the multimedia data receiving apparatus 102 determines that the data necessary for trick play is from the 47940th byte to the 95879th byte, with the beginning of the multimedia data as 0, the multimedia data receiving apparatus 102 issues an HTTP request like the following example, to the multimedia data transmitting apparatus 101, as a multimedia data transmission request including an adjustment request for the data transmission position.

GET http://192.168.0.3/AVData/0001.m2ts HTTP/1.1

Host: 192.168.0.3

Date: Thr Jan. 11 15:00:00 2007 GMT

User-Agent: AVT Client

Connection: Keep-Alive

X-Range-Adjust: bytes=47940-95879; true; true

In the case of receiving such an HTTP request, the multimedia data transmitting apparatus 101 first adjusts the range of the transmission data. In the above-described example, when it is taken into account that the AES encryption block length is 16 bytes, neither the 47940th byte nor the 95879th byte match the encryption block boundaries. Consequently, first, transmission start position is taken as the 47936th byte which is the starting point of the encryption block which includes the 47940th byte. Further, the transmission end position is taken as the 95887th byte which is the ending point of the encryption block including the 95879th byte. Then, with the beginning of the multimedia data as 0, the multimedia data transmitting apparatus 101 transmits the data from the 47936th byte to the 95887th byte, and notifies where within the transmitted 47952 bytes of data the transmission start requested position and the transmission end requested position coincide. In this case, the transmission start requested position coincides with the 4th byte from the beginning of the transmitted 47952 bytes of data, and the transmission end requested position coincides with the 47944th byte from the beginning of the transmitted 47952 bytes of data.

The HTTP response for notifying these is defined as follows. First, in the case of a normal response, 200 OK is used as a response code, and in the case of an improper range designation, a response code of 400 Bad Request is used. Furthermore, the length of the multimedia data included in the response is indicated by Content-Length. In addition, the range of the transmitted data, and the transmission start requested position and the transmission end requested position therein are indicated by X-Content-Range-Adjust. X-Content-Range-Adjust indicates the range of the transmitted data, and the transmission start requested position and the transmission end requested position therein, delimiting these with semicolons. In the case of the above-described example, this becomes as follows.

X-Content-Range-Adjust: bytes=47936-95887; 4; 47944

In the X-Content-Range-Adjust, in the case where position adjustment is not requested for the transmission start requested position or the transmission end requested position, transmission is carried out with that position being made 0. For example, in the case of receiving a request which includes the aforementioned “X-Range-Adjust: bytes=48128-95879; false; true”, the X-Content-Range-Adjust of the response therefor is as follows.

X-Content-Range-Adjust: bytes=48128-95879; 0; 47744

From this, the multimedia data transmitting apparatus 101 transmits to the multimedia data receiving apparatus 102 an HTTP response such as the example below, in response to the aforementioned HTTP request.

HTTP/1.1 200 OK

Date: Thr Jan. 11 15:00:01 2007 GMT

Server: AVT Server

Connection: Keep-Alive

Content-Type: video/mpeg

Content-Length: 47952

X-Content-Range-Adjust: bytes=47936-95887; 4; 47944

(Empty line)

[47952-byte data]

Hereinafter, the multimedia data transmitting apparatus 101 and the multimedia data receiving apparatus 102 included in the multimedia content communication system 104 of the present invention shall be described in more detail.

First, the multimedia data transmitting apparatus 101 shall be described.

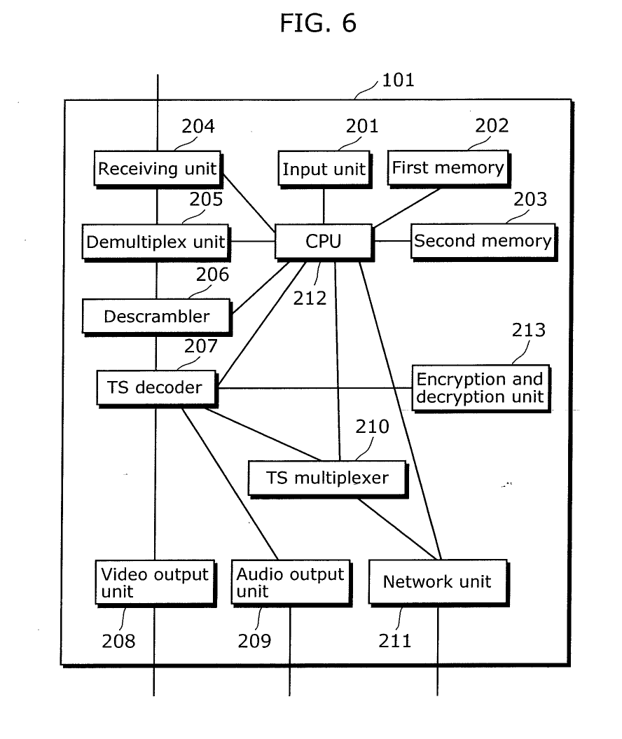

FIG. 6 is a block diagram showing the relationship of constituent elements making up the multimedia data transmitting apparatus 101 in the present embodiment. The multimedia data transmitting apparatus 101 includes an input unit 201, a first memory 202, a second memory 203, a receiving unit 204, a demultiplex unit 205, a descrambler 206, a TS decoder 207, a video output unit 208, an audio output unit 209, a TS multiplexer 210, a network unit 211, a CPU 212, and an encryption and decryption unit 213.

Note that the function of the broadcast signal receiving unit 4001 shown in FIG. 2 is implemented through the execution, by the receiving unit 204 and the CPU 212, of a program stored in the second memory 203. The storage unit 4002 is implemented through the second memory 203. The functions of the message receiving unit 4003 and the data transmitting unit 4006 are implemented through the execution, by the network unit 211 and the CPU 212, of a program stored in the second memory 203. The functions of the Java execution unit 4004 and the transmission position adjustment unit 4005 are implemented through the execution, by the CPU 212, of a program stored in the second memory 203.

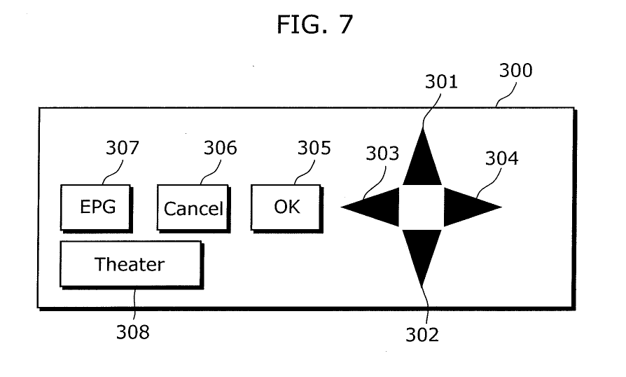

The input unit 201 is configured of a front panel, remote control light receiver, and the like, and accepts an instruction, such as a channel selection, from a user. FIG. 7 shows an example of the input unit 201 in the case where it is configured of a front panel. 300 is a front panel configured of 8 buttons, namely, an up-cursor button 301, a down-cursor button 302, a left-cursor button 303, a right-cursor button 304, an OK button 305, a cancel button 306, an EPG button 307, and a theater button 308. When the user presses down a button, the identifier of such pressed button is notified to the CPU 212.

The first memory 202 is configured of a RAM, or the like, and is used when the CPU 212 temporarily stores data.

The second memory 203 is configured of a device that can hold information even when power is turned off, such as a flash memory, a hard disk, or the like, and stores a program executed by the CPU 212. For the second memory, a detachable storage device such as an SD memory card and the like may also be used.

The receiving unit 204 is connected to the cable from a CATV station from which it receives broadcast waves. The receiving unit 204 tunes to the frequency specified by the CPU 212, extracts an MPEG transport stream and passes this to the demultiplex unit 205.

The demultiplex unit 205 receives the MPEG transport stream from the receiving unit 204, extracts information specified by the CPU 212 and passes it to the CPU 212. In addition, it passes the MPEG transport stream directly to the descrambler 206.

The descrambler 206 descrambles (=decrypts) the scrambled MPEG transport stream provided by the demultiplex unit 205, and passes this to the TS decoder 207. Furthermore, the descrambler 206 also performs the role of extracting information on whether protection is necessary/unnecessary for a TV-program, which is included in the MPEG transport stream, and passing this to the CPU 212. The descrambler 206 may be a module built-into the multimedia data transmitting apparatus 101, and may also be implemented through the CableCARD™ introduced in North American cable receivers. The specifications of CableCARD is described in the CableCARD Interface Specification laid out by the North American CableLabs.

The TS decoder 207 receives identifiers of section data such as audio data, video data, PSI/SI information, and so on, from the CPU 212. In addition, the TS decoder 207 extracts, from the descrambled stream received from the descrambler 206, data corresponding to the received identifiers of section data such as audio data, video data, PSI/SI information, and so on, and passes the extracted video data to the video output unit 208, and the audio data to the audio output unit 209. Furthermore, the TS decoder 207 passes both the video data and the audio data, as well as the section data to the TS multiplexer 210.

The video output unit 208, which includes a video output terminal, converts the received video data to video data that complies with the terminal and outputs this. An example of the terminal is a composite cable terminal, and so on.

The audio output unit 209, which includes an audio output terminal, converts the received video data to video data that complies with the terminal and outputs this. Examples of the terminal are earphone terminals, a composite cable terminal, and so on.

The TS multiplexer 210 configures an MPEG2 transport stream from the received video data, audio data, and section data, and passes the MPEG2 transport stream to the network unit 211. The PSI/SI information can be rewritten as necessary.

The network unit 211, which includes a network interface, converts the data received from the CPU 212 into a signal that is in accordance with the physical media of the network to which the network interface is connected to, and outputs this signal. Furthermore, the network unit 211 receives a signal from the network interface, converts the signal into a packet defined by the IP network, and passes the packet to the CPU 212.

The CPU 212 controls the receiving unit 204, the demultiplex unit 205, the descrambler 206, the TS decoder 207, the TS multiplexer 210, the network unit 211, and the encryption and decryption unit 213 by executing a program stored in the second memory 203.

The encryption and decryption unit 213 performs the encryption of inputted data, and the decryption of inputted encrypted data. The key used in encryption is passed on to the encryption and decryption unit 213 by a secure method such as SAC. Furthermore, there are cases where the inputted data is passed from the CPU 212, and cases where it is passed from the TS decoder 207, the TS multiplexer 210, and the network unit 211. In the latter case, these are controlled by the CPU 212.

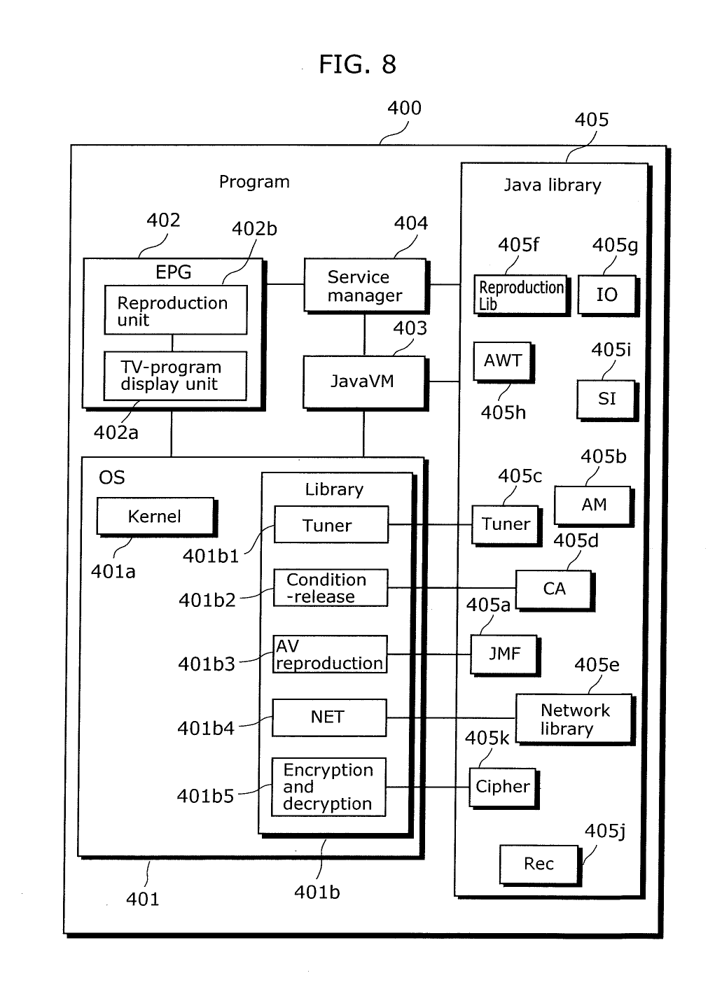

FIG. 8 is an example of a structure diagram of the program stored in the second memory 203 and executed by the CPU 212.

A program 400 is made up of plural subprograms, and is specifically made up of an OS 401 an EPG 402, a Java VM 403, a service manager 404, and a Java library 405.

The OS 401 is a subprogram activated by the CPU 212 when power to the multimedia data transmitting apparatus 101 is turned on. OS stands for operating system, an example of which is Linux and the like. The OS 401 is a generic name for publicly known technology made up of a kernel 401a for executing a subprogram concurrently with another subprogram and of a library 401b, and therefore detailed description is omitted. In the present embodiment, the kernel 401a of the OS 401 executes the EPG 402 and the VM 403 as subprograms. Furthermore, the library 401b provides these subprograms with plural functions required for controlling the constituent elements held by the multimedia data transmitting apparatus 101.

In the present embodiment, the library 401b includes a tuner 401b1, condition-release 401b2, AV reproduction 401b3, a NET 401b4, and encryption and decryption 401b5 as an example of functions.

The tuner 401b1 receives tuning information including a frequency from other subprograms or a Tuner 405c of the Java library 405, and passes this to the receiving unit 204. The receiving unit can perform demodulation based on the provided tuning information, and pass the demodulated data to the demultiplex unit 205. As a result, the other subprograms and the Tuner 405c of the Java library 205 can control the receiving unit 204 through the library 401b.

The condition-release 401b2 receives information from other subprograms or a CA 405d of the Java library 405, and passes this to the descrambler 206.

The AV reproduction 401b3 receives the audio packet ID and video packet ID from the other subprograms or a JMF 405a of the Java library 405. The AV reproduction 401b3 then provides the received audio packet ID and video packet ID to the TS decoder 207. As a result, the TS decoder 207 performs filtering based on the provided packet IDs, and implements the reproduction of audio/video.

The NET 401b4 creates packets of a protocol lower than the application layer defined by the IP network, for the data received from the other subprograms or a network library 405e of the Java library 405. A protocol lower than the application layer refers to, for example, a TCP packet, a UDP packet, an IP packet, and so on. By passing this to the network unit 211, messages and data are transmitted to another device via the network 103. Furthermore, when a message is received from another device via the network 103, the NET 401b4 converts the message to an application layer protocol packet and passes this to the other subprograms or the network library 405e of the Java library 405. An application layer protocol refers to, for example, HTTP, Real-time Transport Protocol (RTP), and so on.

The encryption and decryption 401b5 receives information from other subprograms or a Cipher 405k of the Java library 405, and passes this to the encryption and decryption unit 213. With this, the encryption and decryption unit 213 receives data, and performs the encryption or decryption of the received data.

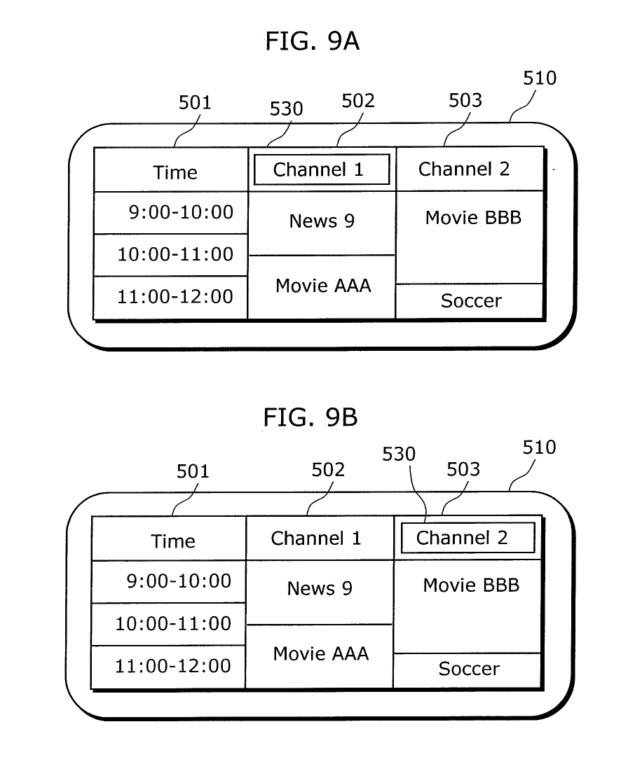

The EPG 402 is made up of a TV-program display unit 402a for displaying a list of TV-programs to the user as well as for accepting an input from the user, and a reproduction unit 402b for selecting channels. Here, EPG is an abbreviation of Electric Program Guide. The EPG 402 is activated by the kernel 401a when power to the multimedia data transmitting apparatus 101 is turned on. Inside the activated EPG 402, the TV-program display unit 402a and the reproduction unit 402b are activated at the same time. When activated, the TV-program display unit 402a waits for an input from the user through the input unit 201 of the multimedia data transmitting apparatus 101. Here, in the case where the input unit 201 is configured of a front panel as shown in FIG. 7, when the user presses down the EPG button 307 of the input unit 201, the identifier of such EPG button is notified to the CPU 212. The TV-program display unit 402a of the EPG 402, which is a subprogram running on the CPU 212, accepts this identifier, then creates TV-program information display data, and displays this on a monitor 510 using a monitor output unit that is not shown in the figure. The monitor 510 may be included in the multimedia data transmitting apparatus 101, and may also be a television connected to the multimedia data transmitting apparatus 101 by a composite cable, HDMI cable, or the like. The monitor 510 displays the received TV-program information display data. FIG. 9A and FIG. 9B are examples of a TV-program list displayed on the monitor 510. Referring to FIG. 9A, TV-program information is displayed on the monitor 510 in a grid pattern. A column 501 displays time information. A column 502 displays a channel name “Channel 1” and TV-programs to be broadcast during time periods corresponding to the respective times described in the column 501. The monitor 510 shows that, on “Channel 1”, a TV-program “News 9” is broadcast from 9:00 to 10:30, and “Movie AAA” is broadcast from 10:30 to 12:00. As in the case of the column 502, a column 503 displays a channel name “Channel 2” and TV shows to be broadcast during time periods corresponding to the respective times described in the column 501. A TV show “Movie BBB” is broadcast from 9:00 to 11:00, and “News 11” is broadcast from 11:00 to 12:00. 530 is a cursor. The cursor 530 moves at the press of the left-cursor 303 or the right-cursor 304 on the front panel 300. When the right-cursor 304 is pressed down in the state illustrated in FIG. 9A the cursor 530 moves towards the right as shown in FIG. 9B. Furthermore, when the left-cursor 303 is pressed down in the state illustrated in FIG. 9B the cursor 530 moves towards the left as shown in FIG. 9A.

When the OK button 305 on the front panel 300 is pressed down in the state shown in FIG. 9A, the TV-program display unit 402a notifies the reproduction unit 402b of the identifier of the “Channel 1”. When the OK button 305 on the front panel 300 is pressed down in the state shown in FIG. 9B, the TV-program display unit 402a notifies the reproduction unit 402b of the identifier of the “Channel 2”.

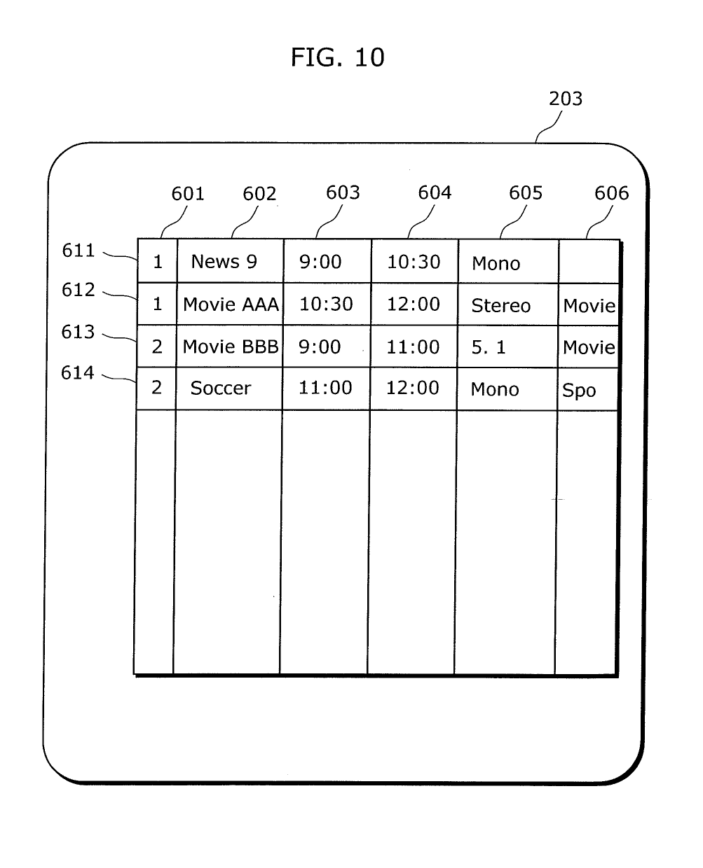

Furthermore, through the demultiplex unit 205, the TV-program display unit 402a regularly stores in advance, in the second memory 203, TV-program information to be displayed. Generally, it takes time to obtain TV-program information from the broadcast station. It is possible to quickly display a TV-program table by displaying the TV-program information previously stored in the second memory 203, at the press of the EPG button 307 of the input unit 201 FIG. 10 shows an example of TV-program information stored in the second memory 203. The TV-program information is stored in tabular form. A column 601 describes the identifiers of channels. A column 602 describes TV-program names. A column 603 describes the broadcast start times of the TV-programs, and a column 604 describes the broadcast end times. A column 605 describes the sound type of the programs, and indicates mono sound, stereo sound, and 5.1 channel sound as “mono”, “stereo”, and “5.1”, respectively. A column 606 describes the type of the programs. A regular TV-program is described as an empty cell, a movie is described as “movie”, and a sports program is described as “spo”. Each of rows 611 to 614 describes information for one TV-program. In this example, one TV-program information is the set of the channel identifier, channel name, broadcast start time, broadcast end time, and TV-program sound type. For example, the row 611 describes a set which includes “1” as the channel identifier, “news 9” as the TV-program name, “9:00” as the broadcast start time, “10:30” as the broadcast end time, “mono” as the sound-type, and “regular” as the TV-program type.

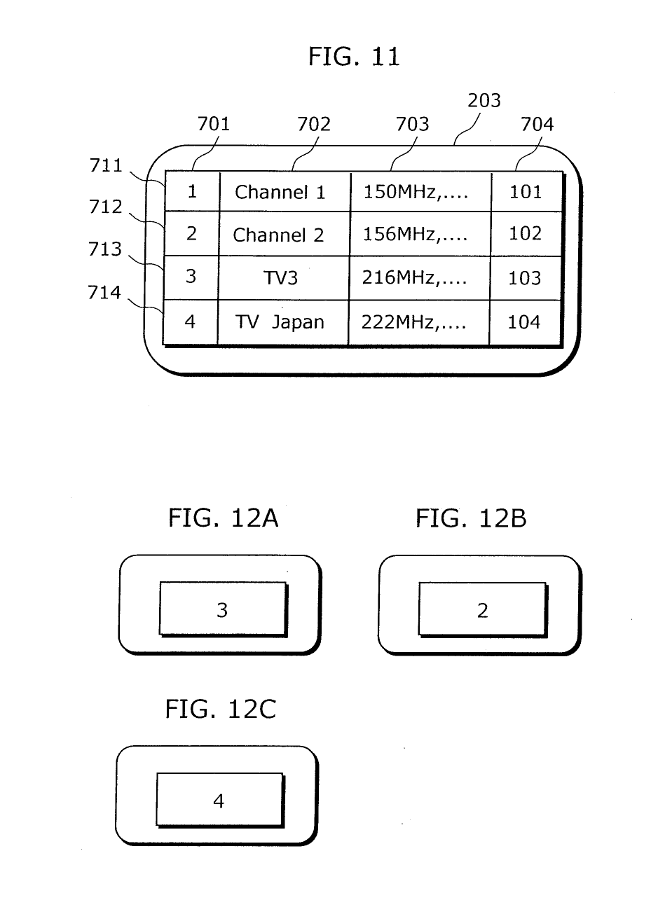

The reproduction unit 402b reproduces a channel using the received identifier of the channel. In other words, it reproduces the video and audio making up the channel. The relationship between channel identifiers and channels is pre-stored in the second memory 203 as channel information. FIG. 11 shows an example of the channel information stored in the second memory 203. The channel information is stored in tabular form. A column 701 describes the identifiers of channels. A column 702 describes channel names. A column 703 describes tuning information. Here, the tuning information are values to be provided to the receiving unit 204, such as frequency, transmission rate, and coding ratio. A column 704 describes program numbers. Program numbers are numbers used to identify PMTs defined by the MPEG-2 standard. A description about PMT is given later. Each of rows 711 to 714 indicates a set of the identifier, channel name, and tuning information of each channel. The row 711 describes a set that includes “1” as an identifier, “Channel 1” as a channel name, a frequency of “150 MHz” as tuning information, and “101” as a program number. The reproduction unit 402b passes the identifier of the received channel directly to the service manager 404 in order to reproduce the channel.

Moreover, when the user presses down the up-cursor 301 and the down-cursor 302 on the front panel 300 while the reproduction is taking place, the reproduction unit 402b receives a notification about such pressing from the input unit 201 through the CPU 212, and changes the channel being reproduced accordingly. When the up-cursor 301 is pressed down, a channel having the next lower channel identifier to that of the currently-reproduced channel is reproduced, and when the down-cursor 302 is pressed down, a channel having the next higher channel identifier to that of the currently-reproduced channel is reproduced. First, the reproduction unit 402b stores, in the second memory 203, the identifier of the channel that is currently reproduced. FIG. 12A, FIG. 12B, and FIG. 12C show example identifiers of channels stored in the second memory 203. FIG. 12A shows that an identifier “3” is stored, and by referring to FIG. 11, it is shown that a channel having the channel name “TV 3” is currently being reproduced. When the user presses down the up-cursor 301 in a state illustrated in FIG. 12A, the reproduction unit 402b refers to the channel information shown in FIG. 11, and passes the identifier “2” of a channel with the channel name of “Channel 2” to the service manager 404 in order to switch reproduction to the channel with the channel name of “Channel 2” which is the channel having an identifier that is one value lower than that of the channel currently being reproduced. At the same time, the reproduction unit 402b rewrites the identifier stored in the second memory 203 to the channel identifier “2”. FIG. 12B shows the state in which the channel identifier has been rewritten. Furthermore, when the user presses down the down-cursor 302 in a state illustrated in FIG. 12A, the reproduction unit 402b refers to the channel information shown in FIG. 11, and passes the identifier “4” of a channel having the channel name of “TV Japan” to the service manager 404 in order to switch reproduction to the channel having the channel name of “TV Japan” which is the channel having an identifier which is one value higher than that of channel currently being reproduced. At the same time, the reproduction unit 402b rewrites the identifier stored in the second memory 203 to the channel identifier “4”. FIG. 12C shows the state in which the channel identifier has been rewritten. The channel identifier is saved, even when power to the multimedia data transmitting apparatus 101 is cut-off, since it is stored in the second memory 203.

In addition, upon being activated when power to the multimedia data transmitting apparatus 101 is turned on, the reproduction unit 402b reads the channel identifier stored in the second memory 203. Then, the reproduction unit 202b passes such channel identifier to the service manager. With this, when power is turned on, the multimedia data transmitting apparatus 101 is able to start the reproduction of the last channel that was being reproduced at the time of its previous operation.

The Java VM 403 is a Java virtual machine that sequentially analyzes and executes programs written in the Java™ language. Programs written in the Java language are compiled into intermediate codes known as a byte code which are not dependent on hardware. A Java virtual machine is an interpreter that executes such byte code. Some Java virtual machines pass the byte code to the CPU 212 after translating the byte code into an execution format which can be interpreted by the CPU 212, and executes it. The Java VM 403 is activated, with a Java program to be executed being specified by the kernel 401a. In the present embodiment, the kernel 401a specifies the service manager 404 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 404, which is a Java program written in the Java language, is sequentially executed by the Java VM 403. It is possible for the service manager 404 to call or be called by another subprogram not written in the Java language, through the Java Native Interface (JNI). The JNI is also described in many publications such as in the book “Java Native Interface” and so on. Here, such details are omitted.

First the process in the case of receiving a digital broadcast, and reproducing the received multimedia data shall be described.

The service manager 404 accepts the identifier of a channel from the reproduction unit 402b, through the JNI.

The service manager 404 first passes the identifier of the channel to the Tuner 405c in the library 405, and requests for tuning. The Tuner 405c refers to the channel information stored in the second memory 203, and obtains the tuning information. Now, when the service manager 404 passes the identifier “2” of the channel to the Tuner 405c, the Tuner 405c refers to the column 712 shown in FIG. 11, and obtains the corresponding tuning information “156 MHz”. The Tuner 405c passes the tuning information to the receiving unit 204 through tuner 401b1 of the library 401b of the OS 401. The receiving unit 204 performs demodulation on the signal transmitted from the broadcast station, based on the provided tuning information, and passes the result to the demultiplex unit 205.

The service manager 404 requests the CA 405d inside the Java library 405 to perform descrambling. The CA 405d provides the descrambler 206 with information required for descrambling, through the condition-release 401b2 of the library 401b in the OS 401. On the basis of such provided information, the descrambler 206 descrambles the signal provided by the receiving unit 204, and passes the result to the TS decoder 207.

The service manager 404 provides the identifier of the channel to a JMF 405a inside the Java library 405, and requests for the reproduction of the video and audio.

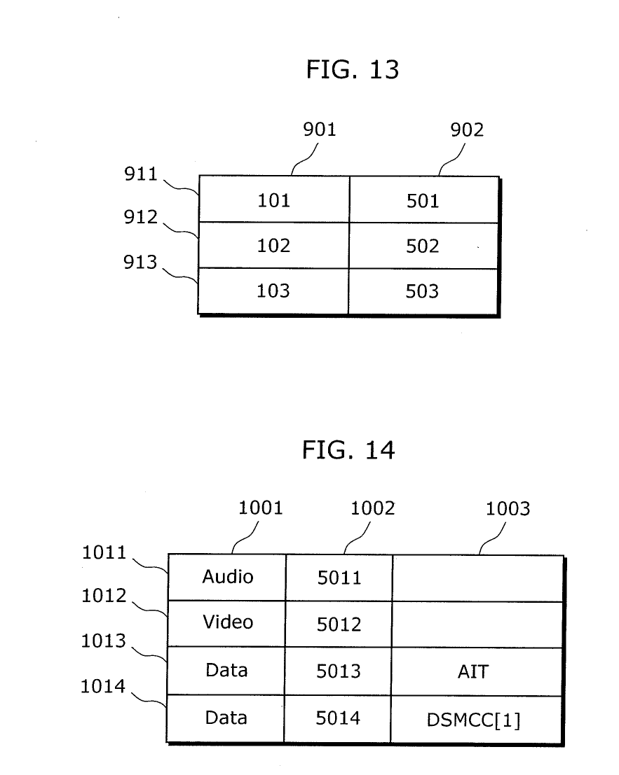

First, the JMF 405a obtains, from a PAT and a PMT, packet IDs used to specify the video and audio to be reproduced. PAT and PMT are tables stipulated by the MPEG-2 standard that show the TV-program line-up included in an MPEG-2 transport stream. PAT and PMT are embedded in the payloads in packets included in an MPEG-2 transport stream, and sent together with audio and video. Refer to the Specification for details. Here, only the outline shall be described. PAT, which is an abbreviation of Program Association Table, is stored and sent in packets with the packet ID “0”. In order to obtain the PAT, the JMF 405a specifies, to the demultiplex unit 205, the packet ID “0”, through the library 401b of the OS 401. The demultiplex unit 205 performs filtering based on the packet ID “0” and, by passing the result to the CPU 212, the JMF 405a collects the PAT packets. FIG. 13 is a chart which schematically shows an example of information of the collected PAT. A column 901 describes program numbers. A column 902 describes packet IDs. The packet IDs shown in the column 902 are used to obtain the PMT. Each of rows 911 to 913 is a pair of the program number of a channel and a corresponding packet ID. Here, three channels are defined. The row 911 defines a pair of the program number “101” and the packet ID “501”. Now, when the channel identifier provided to the JMF 405a is “2”, the JMF 405a refers to the column 912 in FIG. 13, so as to obtain the corresponding program number “102”, and then refers to the column 912 in the PAT shown in FIG. 13, so as to obtain the packet ID “502” corresponding to the program number “102”. PMT, which is an abbreviation of Program Map Table, is stored and sent in packets of the packet ID stipulated in the PAT. In order to obtain the PMT, the JMF 405a specifies the packet ID to the demultiplex unit 205, through the library 401b of the OS 401. Here, it is assumed that the packet ID specified is “502”. The demultiplex unit 205 performs filtering based on the packet ID “502” and, by passing the result to the CPU 212, the JMF 405a collects the PMT packets. FIG. 14 is a chart which schematically shows an example of information of the collected PMT. A column 1001 describes stream types. A column 1002 describes packet IDs. Information specified in the respective stream types is stored and sent in the payloads of packets with the packet IDs specified in the column 1002. A column 1003 describes supplementary information. Each of columns 1011 to 1014 is a pair of a packet ID and the type of information being transmitted, which is known as an elementary stream. The column 1011, which is a pair of the stream type “audio” and the packet ID “5011”, indicates that audio data is stored in the payload of the packet with the packet ID “5011”. The JMF 405a obtains, from the PMT, the packet IDs of the video and audio to be reproduced. Referring to FIG. 14, the JMF 405a obtains the audio packet ID “5011” from the row 1011, and the video packet ID “5012” from the row 1012.

Next, the JMF 405a passes the obtained audio packet ID and video packet ID to the AV reproduction 401b3 of the library 401b of the OS 401. Upon receiving this, the AV reproduction 401b3 provides the received audio packet ID and video packet ID to the TS decoder 207. The TS decoder 207 performs filtering based on such provided packet IDs. Here, the packet with the packet ID “5011” is passed to the audio output unit 209, and the packet with the packet ID “5012” is passed to the video output unit 208. The audio output unit 209 converts (for example, digital-analog conversion) the provided packet, as necessary, and outputs this. The video output unit 208 converts (for example, digital-analog conversion) the provided packet, as necessary, and outputs this.

Finally, the service manager 404 provides the channel identifier to an AM 405b inside the Java library 405, and requests for data broadcast reproduction. Here, data broadcast reproduction refers to extracting a Java program included in the MPEG-2 transport stream, and having it executed by the Java VM 403. As a method of inserting a Java program into an MPEG-2 transport stream, a method referred to as DSMCC, which is described in the MPEG Standard ISO/IEC 13818-6, is being used. Here, detailed description of DSMCC shall be omitted. The DSMCC format defines a method of encoding, in packets within an MPEG-2 transport stream, a file system made up of directories and files used by a computer. Furthermore, information about the Java program to be executed is embedded and sent in packets in the MPEG-2 transport stream in a format referred to as AIT. AIT is an abbreviation of Application Information Table defined in the 10th chapter of the DVB-MHP Standard (formally as, ETS TS 101 812 DVB-MHP Specification V 1.0.2).

First, in order to obtain the AIT, the AM 405b obtains the PAT and PMT as in the case of the JMF 405a, so as to obtain the packet ID of the packet that stores the AIT. Now, when “2” is the identifier of the provided channel and the PAT shown in FIG. 13 and the PMT shown in FIG. 14 are being transmitted, the AM 405b obtains the PMT shown in FIG. 14 according to the same procedure followed by the JMF 405a. The AM 405b extracts, from the PMT, the packet ID of the elementary stream having a stream type of “Data” and which has “AIT” as supplementary information. Referring to FIG. 14, the elementary stream in the row 1013 corresponds to such description, and therefore the AM 405b obtains the packet ID “5013”.

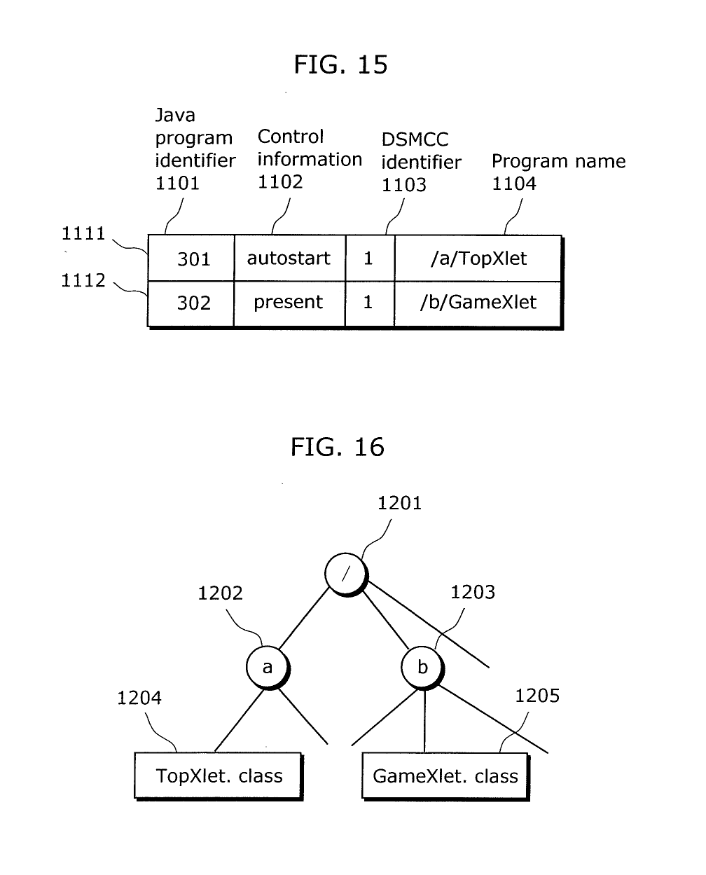

The AM 405b provides the packet ID of the AIT to the demultiplex unit 205, through the library 401b of the OS 401. The demultiplex unit 205 performs filtering based on such provided packet ID, and passes the result to the CPU 212. As a result, the AM 405b can collect the packets of AIT. FIG. 15 is a chart which schematically shows an example of information of the collected AIT. A column 1101 describes the identifiers of Java programs. A column 1102 describes control information of the Java programs. The control information includes “autostart”, “present”, and “kill”. “autostart” means that the multimedia data transmitting apparatus 101 automatically executes the program immediately. “present” means that the program is not executed automatically. “kill” means that the program is to be terminated. A column 1103 describes DSMCC identifiers for extracting packet IDs including a Java program in the DSMCC format. A column 1104 describes program names of the Java programs. Each of rows 1111 and 1112 is a set of information about a Java program. The Java program defined in the row 1111 is a set of an identifier “301”, control information “autostart”, a DSMCC identifier “1”, and a program name “a/TopXlet”. The Java program defined in the row 1112 is a set of an identifier “302”, control information “present”, a DSMCC identifier “1”, and a program name “b/GameXlet”. Here, the two Java programs have the same DSMCC identifier which indicates that two Java programs are included within a single file system encoded in the DSMCC format. Here, only four items of information are stipulated for the respective Java programs, but more items of information are specified in actuality. Refer to the DVB-MHP standard for details.

The AM 405b finds the “autostart” Java program from within the AIT, and extracts the corresponding DSMCC identifier and Java program name. Referring to FIG. 15, the AM 405b extracts the Java program in the row 1111, and obtains the DSMCC identifier “1” and the Java program name “a/TopXlet”.

Next, using the DSMCC identifier obtained from the AIT, the AM 405b obtains, from the PMT, the packet ID of packets that store Java programs in the DSMCC format. More specifically, the AM 405b obtains, from within the PMT, the packet ID of the elementary stream whose stream type is “Data” and having a matching DSMCC identifier in the supplementary information.

Now, assuming that such DSMCC identifier is “1” and the PMT is that shown in FIG. 14, the elementary stream in the row 1014 matches, and the packet ID “5014” is to be extracted.

The AM 405b specifies the packet ID of the packet in which data is embedded in the DSMC format, to the demultiplex unit 205, through the library 401b of the OS 401. Here, the packet ID “5014” is provided. The demultiplex unit 205 performs filtering based on such provided packet ID, and passes the result to the CPU 212. As a result, the AM 405b can collect the required packets. The AM 405b reconstructs the file system from the collected packets, according to the DSMCC format, and stores this in the first memory 202 or the second memory 203. Extracting the data of a file system, and the like, and storing this in the first memory 202 or the second memory 203 shall hereafter be referred to as download.

FIG. 16 shows an example of a downloaded file system. In the figure, a circle denotes a directory and a square denotes a file. 1201 denotes a root directory, 1202 denotes a directory “a”, 1203 denotes a directory “b”, 1204 denotes a file “TopXlet.class”, and 1205 denotes a file “GameXlet.class.

Here, although an example of downloading a file system from an MPEG2 transport stream is described, the OCAP specification also stipulates downloading using an IP network, and so on. Furthermore, a method for identifying the location of a file system using information referred to as XAIT, instead of AIT, and downloading the file system is also stipulated Next, the AM 405 passes, to the Java VM 403, the Java program to be executed from within the file system downloaded into the first memory 202 or the second memory 203. Here, when the name of the Java program to be executed is “a/TopXlet”, the file “a/TopXlet.class”, having “.class” added to the end of the Java program name, is the file to be executed. “/” is a division of a directory and file name and, by referring to FIG. 16, the file 1204 is the Java program to be executed. Next, the AM 405b passes the file 1204 to the Java VM 403.

The Java VM 403 executes the Java program passed to it.

Upon receiving an identifier of an other channel, the service manager 404 stops the execution, though the respective libraries included in the Java library 405, of the video/audio and Java program currently being reproduced likewise through the respective libraries included in the Java library 405, and performs the reproduction of video/audio and execution of a Java program based on the newly received channel identifier.

Furthermore, the service manager 404 also includes a function for receiving the identifier of a channel from a Java program executed on the Java VM 403, aside from the reproduction unit 402b. Specifically, a Java language class for obtaining the identifier of the channel, and the method thereof, are provided. Upon receiving an identifier of a channel, the service manager 404 stops the execution, though the respective libraries included in the Java library 405, of the video/audio and Java program currently being reproduced likewise through the respective libraries included in the Java library 405, and subsequently performs the reproduction of new video/audio and the execution of a Java program based on the newly received channel identifier.

Next, the operation of receiving a digital broadcast and storing the multimedia data thereof, in the multimedia data transmitting apparatus 101 shall be described.

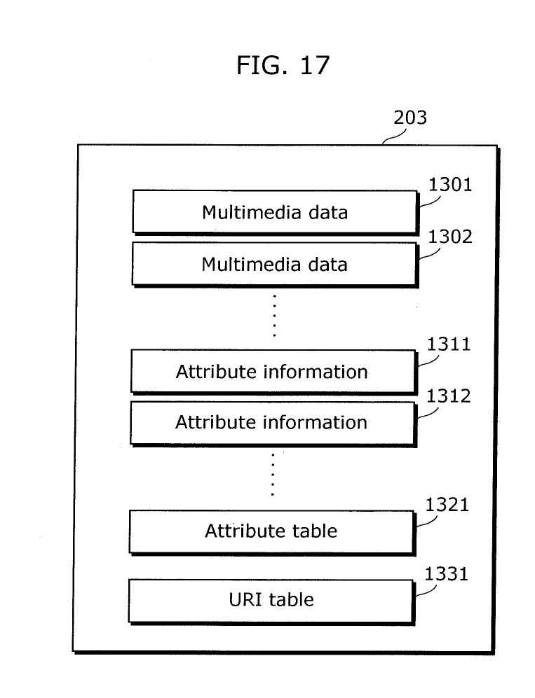

FIG. 17 is an example of the form of the storing of multimedia data into the second memory 203 by the multimedia data transmitting apparatus 101. The multimedia data transmitting apparatus 101 stores, in the second memory 203, multimedia data and its attribute information, an attribute information table, and a URI table. In FIG. 17, 1301, 1302, . . . denote multimedia data, 1311, 1312, . . . denote attribute information of the multimedia data, 1321 denotes an attribute information table, and 1331 denotes a URI table. The multimedia data 1301, 1302, . . . are multimedia data that are encoded in the MPEG-2 TS format, and encrypted. The attribute information 1311, 1312, . . . are additional information such as the title of each multimedia data. Here, the attribute information 1311 describes attribute information of the multimedia data 1301, the attribute information 1312 describes attribute information of the multimedia data 1302.

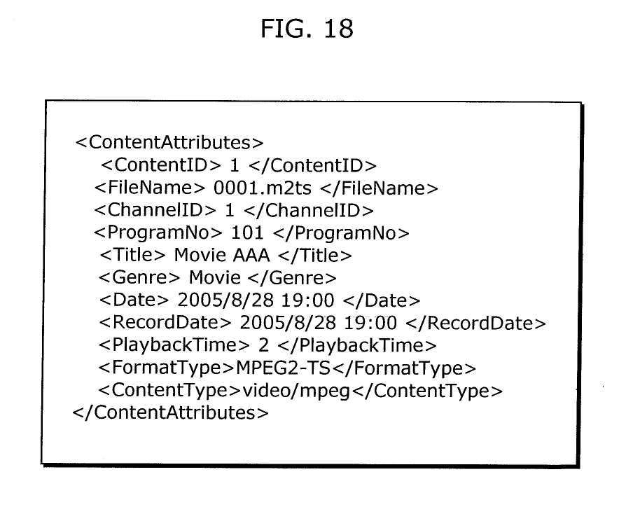

FIG. 18 shows an example of attribute information in the present embodiment. In the present embodiment, attribute information is text defined in the Extensible Markup Language (XML). In FIG. 18, a ContentID element describes the identifier of a content; a FileName element describes the filename of the multimedia data; a ChannelID element describes an identifier of a channel on which the TV-program was broadcast, as shown in column 601 in FIG. 10; a ProgramNo element describes a program number for searching the PMT, as shown in column 704 in FIG. 11; a Title element describes the TV-program name as shown in column 602 in FIG. 10; a Genre element describes the type of the program, as shown in column 606 in FIG. 10; a Date element describes the date and time at which the TV-program was broadcast; a RecordDate element describes the date and time at which the TV-program was recorded; a PlaybackTime element describes the number of times the multimedia data has been reproduced or outputted to the network 104; a FormatType element describes the type of the media format of the content; and a ContentType element describes the Content-Type assigned to the media format of the content from the Internet Assigned Numbers Authority (IANA). Note that the attribute information is not limited to the XML configuration, and recording in other formats such as binary data is also possible.

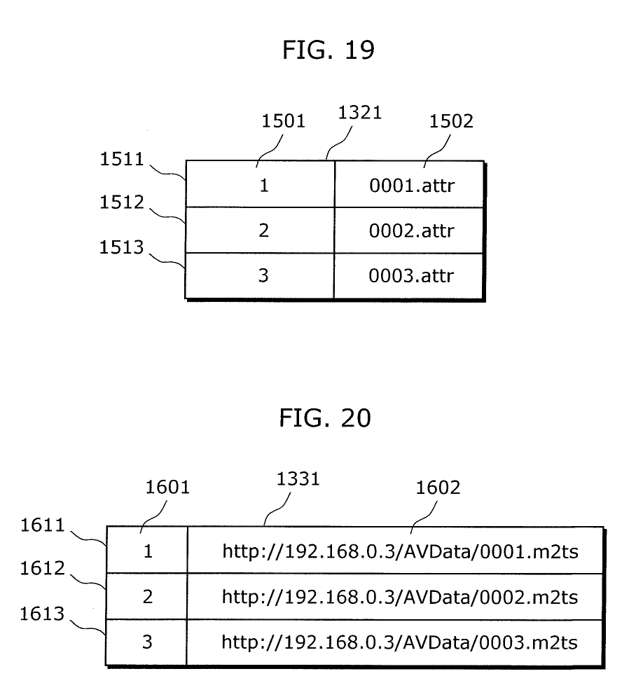

The attribute information table is a correspondence chart for the identifier of the content, the file on which the multimedia data of the content indicated by the identifier is recorded, and the file on which the attribute information is recorded. FIG. 19 shows an example thereof. In FIG. 19, a column 1501 describes the content identifiers, and a column 1502 describes file names of the attribute information. Rows 1511 to 1513 are pairs of the content identifier and the file name of the corresponding attribute information. From column 1511, it can be read that the attribute information of the content for identifier 1 is recorded in the file 0001.attr.

FIG. 20 shows an example of the structure of the URI table 1331. In FIG. 20, a column 1601 describes the identifiers of respective contents, and a column 1602 describes URIs for accessing the respective contents. Rows 1611 to 1613 show pairs of the identifier and URI of respective contents. For example, row 1611 indicates that the URI of the content for identifier 1 is http://192.168.0.3/AVData/0001.m2ts.

Hereinafter, the storing process shall be described. First, the operation up to descrambling is the same as in the case of the previously described reproduction. Next, the service manager 404 requests, the CA 405d, for the obtainment of protection necessary/unnecessary information concerning the multimedia data and, in the case where protection is necessary, information on the kind of protection. This information shall be called protection information. The CA 405d receives the protection information of the multimedia data from the descrambler 206, and passes this to the service manager 404. Next, the service manager 404 judges, from the protection information passed on to it, whether or not the multimedia data can be stored. Only in cases where storing is possible does the service manager 404 request the storing of the multimedia data, to the Rec 405j inside the Java library 405. The Rec 405j first obtains the PAT and PMT in the same manner as the JMF 405a and AM 405b, and obtains packet IDs for the video data, audio data, and respective section data relating to the TV-program to be stored. Now, when “2” is the identifier of the provided channel and the PAT shown in FIG. 13 and the PMT shown in FIG. 14 are being transmitted, the Rec 405j obtains the PMT shown in FIG. 14 according to the same procedure followed by the JMF 405a. The data to be stored are all the data described in the PMT in FIG. 14.

The Rec 405j provides these packet IDs to the decoder 207 through the library 401b of the OS 401 and causes these to be outputted to the TS multiplexer 210. The TS decoder 207 performs filtering based on such provided packet IDs, and passes the result to the TS multiplexer 210. Furthermore, with regard to the section data, it is possible that a version number is assigned to each section data, and that the TS decoder 207 outputs data of the same type only once for each version number, and filters the rest.

The Rec 405j provides, to the TS multiplexer 210 through the library 401b of the OS 401, the number of types of data to be transmitted, and causes the configuration of an MPEG2 transport stream from the data passed on from the TS decoder 207.

In addition, by requesting the Cipher 405k inside the Java library 405, the Rec 405j sets the encryption and decryption unit 213 to perform the encryption of the data, through the Java library 405 of the OS 401. With this, the TS multiplexer 210 passes the configured MPEG transport stream to the encryption and decryption unit 213. Furthermore, the encryption and decryption unit 213 passes the encrypted data to the CPU 212.

In addition, the Rec 405j writes, into the second memory, the encrypted MPEG transport stream received by the CPU 212 from the encryption and decryption unit 213, by requesting the IO 405g inside the Java library 405. In addition, the Rec 405j receives the channel identifier of the channel by requesting the service manager 404, and reads the TV-program information corresponding to the stored multimedia data from among the TV-program information stored in the second memory 203 shown in FIG. 10, by requesting the IO 405g. In addition, the Rec 405j obtains the identifier of the stored multimedia data, by requesting the service manager 404. Furthermore, the Rec 405j creates attribute information from the obtained TV-program information, the identifier of the multimedia data, and the file name under which the multimedia is stored, and writes the attribute information into the second memory 203 by requesting the IO 405g. In addition, the Rec 405j reads the attribute information table by requesting the IO 405g, updates the attribute information and, by requesting the IO 405g, updates the information table by writing into the second memory 203.

Note that although, in the present embodiment, the descrambler 206 obtains the protection information of the content and passes this to the CPU 212, it is also possible to have the demultiplex unit 205 or the TS decoder 207 obtain the protection information and pass this to the CPU 212. Alternatively, it is also possible to provide a unit which communicates with the broadcast station 105 and receive the protection information separately from the broadcast station 105. Alternatively, it is also possible to embed and broadcast the protection information in a PMT, and have the TS decoder 207 or the CPU 212 extract the protection information from the PMT.

Furthermore, the key used in the encryption by the encryption and decryption unit 213 may be generated by the CPU 212, and may also be passed on from the broadcast station 105. Furthermore, this key is encoded and stored beforehand in the second memory 203.

Next, the processing in the case of outputting the multimedia data of a received digital broadcast from the network unit 211.

First, the network library 405e located inside the Java library 405 receives a request from a terminal connected to the network 103, and provides the identifier of the channel being requested, to the service manager 404. The service manager 404 provides the received channel identifier to the Tuner 405c and requests tuning, then requests descrambling to the CA 405d, and returns the process to the network library 405e.

The network library 405e controls the TS decoder 207 and the TS multiplexer 210 and creates an MPEG transport stream from the video data, audio data, and section data of the TV-program, in the same manner as the Rec 405j described above.

In addition, the network library 405e provides the address of the transmission destination to the NET 401b4 of the library 401b of the OS 401. Next, the network library 405e converts the MPEG-2 transport stream received from the TS multiplexer 210 into a format that is in accordance with the protocol of the application layer to be transmitted, and outputs this sequentially to the NET 401b4. An application layer protocol refers to, for example, HTTP, RTP, and so on. With this, the NET 401b4 refers to the transmission destination address, and converts the data passed on to it into IP network packets and passes these to the network unit 211. The network unit 211 converts the data passed on to it into a signal that is in accordance with the physical media of the network connected to, and outputs this signal.

Note that the network library 405e may perform encryption of data and transmit the encrypted data. In this case, by requesting the Cipher 405k inside the Java library 405, the network library 405e sets the encryption and decryption unit 213 to perform the encryption of the data, through the library 401b of the OS 401. Next, the TS multiplexer 210 sets the encryption and decryption unit 213 to output the data. With this, the network library 405e can receive the encrypted MPEG2 transport stream. Next, the network library 405e converts the received MPEG-2 transport stream into a format that is in accordance with the protocol of the application layer to be transmitted, and outputs this sequentially to the NET 401b4, thereby performing the transmission of encrypted data.

Next, the process in the case of reproducing multimedia data stored in the second memory 203 shall be described. Upon receiving the content identifier, the service manager 404 reads the attribute information table 1321 from the second memory 203 and searches for the file on which the attribute information of the contents for the identifier is recorded, by requesting the IO 405g inside the Java library 405. In the attribute information table in FIG. 19, when the content identifier is 1, the file is 0001.attr. Next, by requesting the IO 405g, the service manager 404 reads the file on which the attribute information is recorded, from the secondary memory 203. The service manager 404 obtains the file name on which the multimedia data of the content is recorded, from the read attribute information. In the case of the attribute information in FIG. 18, 0001.m2ts corresponds to the file name.

Next, by requesting the Cipher 405k, the service manager 404 sets the encryption and decryption unit 213 to perform decryption.

Next, by requesting the IO 405g, the service manager 404 reads the encrypted MPEG transport stream from the file of the multimedia data. The IO 405g reads the data through the library 401b of the OS 401, and passes the data to the CPU 212. The service manager 404 passes the read encrypted MPEG transport stream to the encryption and decryption unit 213 via the encryption and decryption 401b5. The encryption and decryption unit 213 decrypts the received data and passes the decrypted data to the CPU 212. The service manager 404 passes the received decrypted MPEG transport stream to the demultiplex unit 205, through the library 401b of the OS 401.

In addition, the service manager 404 requests the CA 405d inside the Java library to allow the data to pass through without being descrambled by the descrambler. The CA 405d provides the descrambler 206 with information, through the condition-release 401b2 of the library 401b in the OS 401. With this, the descrambler 206 passes the data passed on to it by the demultiplex unit 205, as-is, to the TS decoder 207.

In addition, the service manager 404 reads the channel identifier or program number from the read attribute information, provides this to the JMF 405a inside the Java library 405, and requests for reproduction. Hereafter, the reproduction of video data and audio data is performed according to the same process as in the previously described case of a content received from a broadcast.

Furthermore, the service manager 404 provides the channel identifier or the program number to the AM 405b inside the Java library, and requests for data broadcast reproduction. Hereafter, the data broadcast reproduction is performed according to the same process as in the previously described case of a content received from a broadcast.

Next, the process of transmitting, from among the multimedia data stored in the second memory 203, multimedia data requested by a terminal connected to the network 103 to the request-source terminal shall be described.

First, the network library 405e analyzes the request message transmitted from the request-source terminal, and obtains the URI of the requested content. This is carried out through the network library 405e analyzing the activated server module, the port number of the server to which the terminal has connected with, and the request message. Next, the network library reads the URI table 1331 by requesting the IO 405g. The identifier of the requested content is obtained from the read URI table 1331 and the URI obtained from the request message. For example, in the URI table shown in FIG. 20, when the requested URI is http://192.168.0.3/AVData/0001.m2ts, a content identifier 1 is obtained from the details in row 1611.

Next, the network library 405e reads the attribute information table 1321 by requesting the IO 405g. Subsequently, the file name of the attribute information file of the content is obtained based on the identifier of the requested content. For example, in the attribute information table 1321 shown in FIG. 19, it can be seen that the attribute information file of the content of identifier 1 is 0001.attr.

Next, the network library 405e reads the attribute information of the obtained file name by requesting the IO 405g. The network library 405e obtains, from the FileName element among the read attribute information, the file name on which the multimedia data of the content is recorded. For example, in the case of the attribute information file shown in FIG. 18, it can be seen that the file name of the multimedia data is 0001.m2ts.

Next, the network library 405e verifies the presence of the multimedia data of the obtained file name by requesting the 10 405g. When not present, the network library 405e generates an error message, transmits this to the request-source terminal, and ends the process. When present, the network library 405e collects information, such as information of the attribute information size and the file size, which are obtainable by requesting the IO 405g, generates the header of a reply message, and transmits the header to the request-source terminal. Next, by requesting the IO 405g, the network library 405e sequentially reads the multimedia data and transmits the read data to the request-source terminal.

Furthermore, in the case where the transmission range is designated by the request-source terminal, the network library 405e reads the corresponding part of the multimedia data by requesting the IO 405g, collects information such as the data size of the multimedia data and creates a reply message header, and transmits this to the request-source terminal. Next, the network library 405e transmits the read relevant part of the multimedia data to the request-source terminal.

In addition, in the case where a transmission request including a transmission position adjustment request is received from the request-source terminal, the network library 405e first performs the adjustment of the transmission start position and the transmission end position, as described above. Furthermore, the network library 405e reads the data of the section of the adjusted transmission start position and transmission end position by requesting the IO 405g, collects required information and creates a reply message header, and transmits this to the request-source terminal, then transmits the read corresponding part of the multimedia data.

The Java library 405 is a collection of plural Java libraries stored in the second memory 203. In the present embodiment, the Java library 405 includes the JMF 405a, the AM 405b, the Tuner 405c, the CA 405d, the network library 405e, a reproduction Lib 405f, the IO 405g, an AWT 405h, an SI 405i, the Rec 405j and the Cipher 405k, is and so on.

Since the functions of the JMF 405a, the AMF 405b, the Tuner 405c, the CA 405d, and the Rec 405j have already been described, further description shall be omitted.

The reproduction Lib 405f provides the class and method of the Java language (hereafter called Java API) for passing, to the Java program, the identifier of the channel currently being reproduced, which is stored in the second memory 203. By using this Java API, the Java program is able to recognize the channel that is currently being reproduced.

The IO 405g provides, to the Java program, Java API for the writing of data to the second memory 203 by the Java program, or Java API for the reading of such data which has been written into the second memory 203. By using this API, the Java program is able to store arbitrary data in the secondary memory 203. Since such stored data is not erased even when power to the multimedia data transmitting apparatus 101 is turned off, the data can be read again after power to the multimedia data transmitting apparatus 101 is turned on.

The AWT 405h provides Java API for drawing or for the reception of a key input notification from the input unit 201 by the Java program. To be more specific, these correspond to the java.awt package, java.awt.event package, and other java.awt subpackages described in “The Java class Libraries Second Edition, Volume 2” (ISBN0-201-31003-1). Here, detailed description shall be omitted.

The SI 405i provides Java API for the obtaining of channel information and electric program information by the Java program. To be more specific, there are the Java TV Specification and the like. Furthermore, the MPEG section filter API for obtaining raw binary data from an MPEG-2 transport stream currently being broadcast is defined in the OCAP Specification, and the Java application can understand and handle unique electric program data that has been transmitted.

The Cipher 405k provides, through the encryption and decryption 401b inside the library 401b of the OS 401, Java API for controlling the encryption and decryption unit 213. Using this Java API, the encryption and decryption unit 213 can be made to perform the encryption or decryption of data.

The network library 405e, connected to the network 103, communicates with the multimedia data receiving apparatus 102 through the NET 401b4 of the library 401b of the OS 401. The communication includes receiving a request from the multimedia data receiving apparatus 102, and transmitting a content list or EPG, and multimedia data in response to such request.

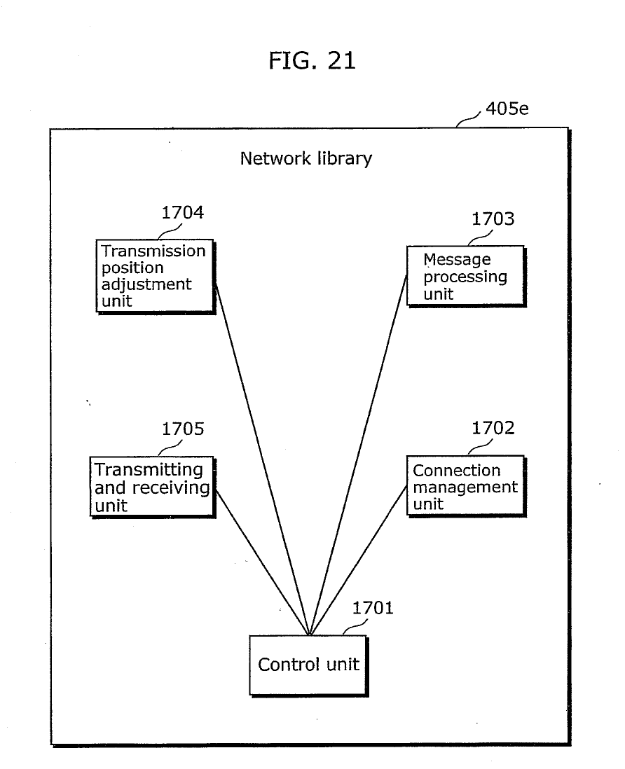

FIG. 21 is a block diagram showing an example of the internal configuration of the network library 405e. The network library 405e includes a control unit 1701, a connection management unit 1702, a message processing unit 1703, a transmission position adjustment unit 1704, and a transmitting and receiving unit 1705. Note that the network library 405e may include other functions relating to the IP network.

The control unit 1701 provides, to a downloaded Java application, the function for implementing the network library 405e. In other words, the control unit 1701 can execute a network-using function by providing Java API to the Java application, and by the Java application calling such API. When the Java API is called, the control unit 1701 performs processes using the connection management unit 1702, the message processing unit 1703, the transmission position adjustment unit 1704, the transmitting and receiving unit 1705, and the rest of the Java library 405 and the library 401b of the OS 401, as necessary. Furthermore, the control unit 1701 carries out notifications to the Java application using a callback function of the Java application, as necessary.

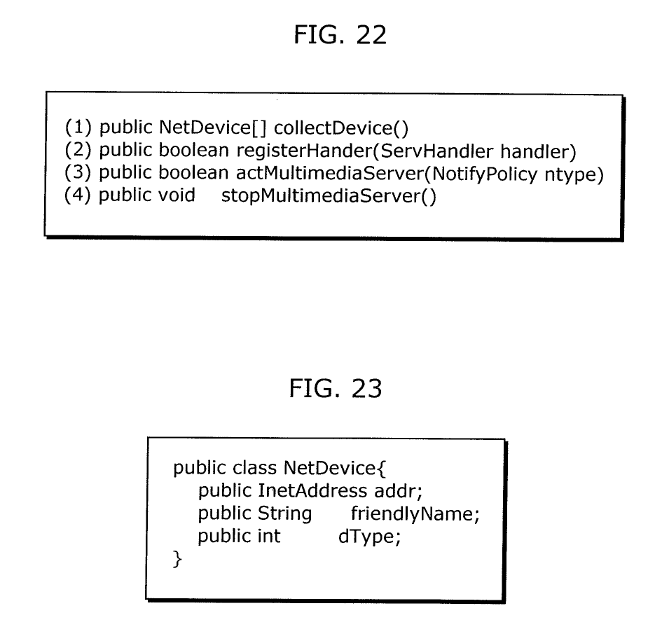

FIG. 22 is an example of the Java API provided by the control unit 1701. The method collectDevice( ) in FIG. 22(1) collects information on an external device connected to the network 103, and returns, as information thereon, the array of NetDevice object. In the case of failure, null is returned. With this method, it is possible to obtain information on the device connected to the network 103. FIG. 23 shows an example of the structure of a NetDevice class. In FIG. 23, addr represents the network address of the device, friendlyName represents the nickname given to the device, dType represents the type of the device; 0 represents the multimedia data transmitting apparatus in the present invention; 1 represents the multimedia data receiving apparatus in the present invention.

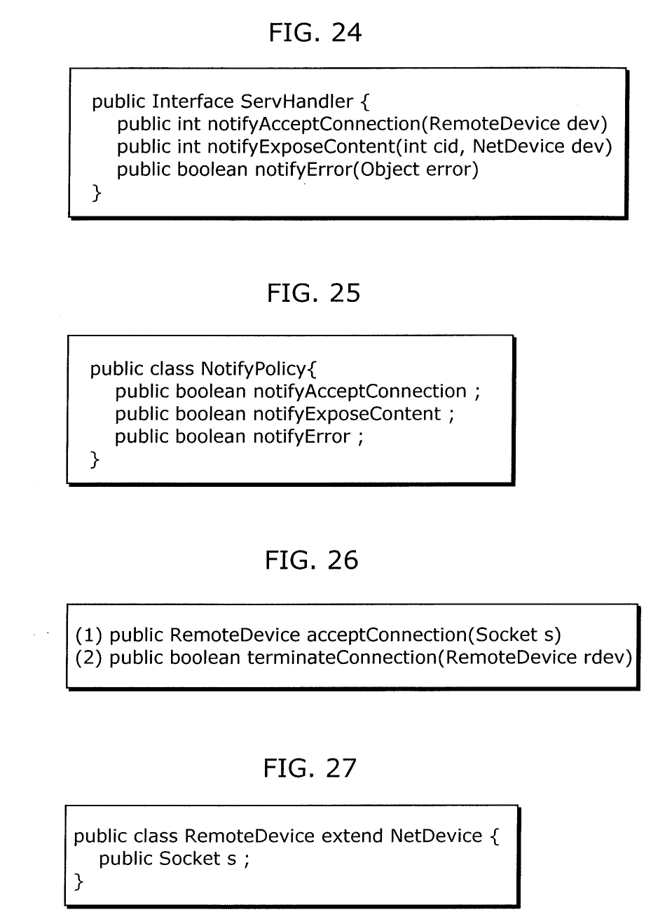

The method registerHandler( ) in FIG. 22(2) registers, into the system, a ServHandler interface-equipped handler which is provided through an argument handler, and returns true when successful and false in the case of a failure. By registering the handler, the Java application can receive a callback from the network library 405e. FIG. 24 shows an example of the structure of the ServHandler interface. In FIG. 24, the method notifyAcceptConnection( ) of the ServHandler interface notifies, from the network library 405e to the Java application, the fact that the network connection from the device indicated by the argument dev has been accepted. It returns 0 in the case of normal ending, and returns an error code when any trouble occurs. Furthermore, the method notifyExposeContent( ) notifies, from the network library 405e to the Java application, the fact that the content of the identifier indicated by the argument cid has been outputted to the device indicated by the argument dev via the network 103. It returns 0 in the case of normal ending, and returns an error code when any trouble occurs. Furthermore, the method notifyError( ) notifies, from the network library 405e to the Java application, the fact that some error has occurred during operation as a multimedia server. It returns 0 in the case of normal ending, and returns an error code when any trouble occurs. An argument object indicates an error such as Java Exception. Whether or not these callbacks to the Java application are to be carried out is set in the network library 405e from the Java application, according to a NotifyPolicy described later.

The method actMultimediaServer( ) in FIG. 22(3) requests, from the Java application to the network library 405e, the activation and operation of a multimedia server function. It returns true when the process ends normally, and returns false when an error occurs. When this method is called, the control unit 1701 of the network library 405e, as necessary, performs processing as a multimedia server providing multimedia data, by using the connection management unit 1702, the message processing unit 1703, the transmission position adjustment unit 1704, the transmitting and receiving unit 1705, and the rest of the Java library 405 and the library 401b of the OS 401, and in addition, by carrying out notification to the Java application and the service manager 404. The argument ntype sets whether or not there is a need for a callback from the network library 405e, and specifies this through the instance of the NotifyPolicy class. FIG. 25 shows an example of the NotifyPolicy class. In FIG. 25, a member variable notifyAcceptConnection of the NotifyPolicy class is a boolean variable. It sets the performance of a callback according to the method notifyAcceptConnection( ) of the handler equipped with the ServHandler interface set in the network library 405e in the case of true, and sets the non-performance of the callback in the case of false. Furthermore, a member variable notifyExposeContent is a boolean variable which sets the performance of a callback according to the method notifyExposeContent( ) in the case of true, and sets the non-performance of the callback in the case of false. Furthermore, a member variable notifyError is a boolean variable which sets the performance of a callback according to the method notifyError( ) in the case of true, and sets the non-performance of the callback in the case of false. Details of the operation of the method actMultimediaServer( ) shall be described later.

The method stopMultimediaServer( ) in FIG. 22(4) requests, from the Java application to the network library 405e, the termination of the multimedia server activated according to the method actMultimediaServer. When this method is called, the network library 405e terminates the operation of the currently activated multimedia server.

The connection management unit 1702 manages the network session with a device connected to the network 103.

The connection management unit 1702 provides Java API to the other constituent elements of the network library 405e and the downloaded Java application. FIG. 26 is an example of the Java API provided by the connection management unit 1702. A method acceptConnection( ) in FIG. 26(1), according to the Socket object provided by the argument s, goes on standby for an external device, establishes a connection with the device requesting connection, and returns information on the device as well as a RemoteDevice object including a Socket object communicating with the device. It returns the RemoteDevice object when successful, and returns null in the case of failure. FIG. 27 shows an example of a RemoteDevice class. In FIG. 27, the RemoteDevice class is an extension class of the NetDevice class, which holds information on a socket for which a connection has been established, using a Socket-type member variable s. In the process for this method, for example, in the case where a connection request for an HTTP session is received from a terminal, it is possible to generate a RemoteDevice object from the Socket object for transmitting and receiving an HTTP message and the IP address of the requesting terminal. Note that this method may be further provided with an array of the NetDevice objects as an argument, and respond only to a connection request from a device indicated by the respective elements of the array. Furthermore, it is also possible that in the present method, the array of the NetDevice objects is likewise provided as an argument and, in the case of a connection request from a device indicated by the respective elements of the array, the RemoteDevice object is generated from the Socket object communicating with the corresponding NetDevice.

Furthermore, a method terminateConnection( ) in FIG. 26(2) terminates the network connection with the external device provided by the argument rdev. It returns true in the case of normal termination, and returns false in the case where any error occurs.

The message processing unit 1703 interprets a request message received via the network 103, and generates a reply message.

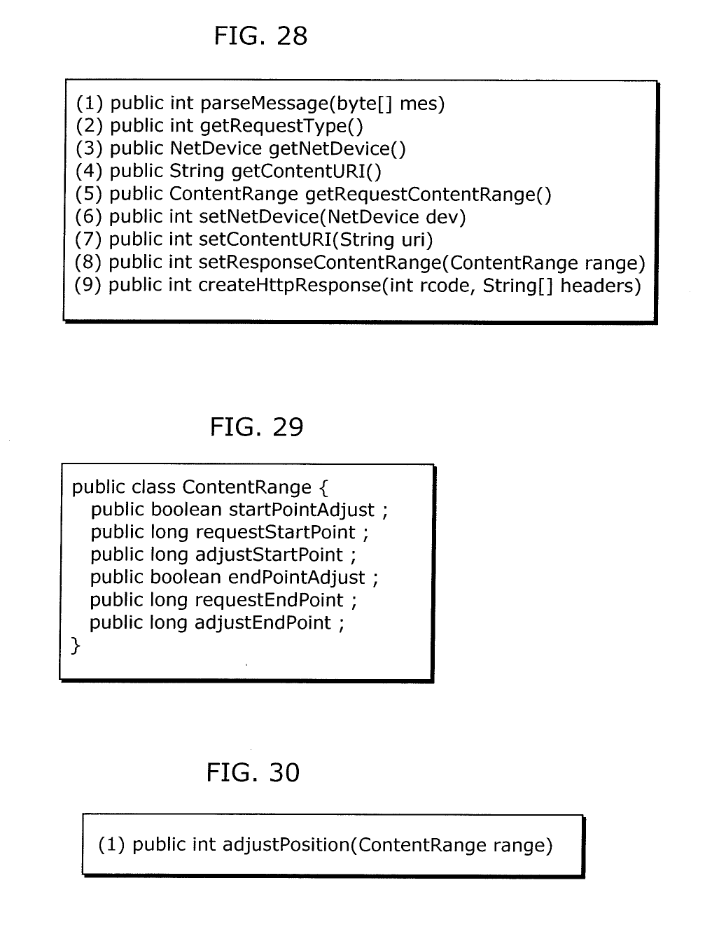

The message processing unit 1703 provides Java API to the control unit 1701 and the downloaded Java application. FIG. 28 is an example of the Java API provided by the message processing unit 1703. A method parseMessage( ) in FIG. 28(1) analyzes the request message provided by an argument mes which is a byte-type array. The method parseMessage( ) returns 0 when successful, and returns a non-0 error code in the case of failure. Data provided by the argument mes is data received by the transmitting and receiving unit 1705 to be described later.

A method getRequestType( ) in FIG. 28(2) returns the type of a successfully interpreted request message. It returns a positive value representing the type when successful, and returns an negative value error code in the case of failure. In the present embodiment, 1 is returned in the case of HTTP-GET which is the transmission request for multimedia data, and 2 is returned in the case of HTTP-HEAD in which only a header is returned and data is not transmitted.

A method getNetDevie( ) in FIG. 28(3) returns, using an instance of the NetDevice class, information on the transmission-source terminal, which is read from the message. The method getNetDevie( ) returns null when reading is unsuccessful or in the case of failure.

A method getContentURI( ) in FIG. 28(4) returns the URI of the content requested in the message, using a String instance, and returns null when interpreting is unsuccessful or in the case of failure. In this method, a valid value is returned only in the case where the request message is a multimedia data transmission request.

A method getRequestContentRange( ) in FIG. 28(5) returns, using an instance of a ContentRange class to be described later, the transmission start requested position and the transmission end requested position of the multimedia data included in the message, as well as the presence or absence of a request for position adjustment. It returns null in the case where a transmission position designation is not included in the message. Furthermore, FIG. 29 shows an example of the ContentRange class. In FIG. 29, a member variable startPointAdjust is a boolean variable in which true is set in the case where the adjustment of the transmission start position is requested, and false is set in the case where the request is not made. Furthermore, the member variable requestStartPoint is a long-type variable which supplies the transmission start requested position from the terminal. In the case where the transmission start requested position is not designated, the member variable requestStartPoint is set to 0. Furthermore, a member variable adjustStartPoint is a long-type variable which supplies the transmission start position adjusted by the transmission position adjustment unit 1704 described later. In the case where the adjustment of the transmission start position is not requested, the member variable adjustStartPoint supplies the same position as that with the member variable requestStartPoint. Furthermore, a member variable endPointAdjust is a boolean variable in which true is set in the case where the adjustment of the transmission end position is requested, and false is set in the case where the request is not made. Furthermore, a member variable requestEndPoint is a long-type variable which supplies the transmission end requested position from the terminal. In the case where the transmission end requested position is not designated, the member variable requestEndPoint is set to a negative value. Furthermore, a member variable adjustEndPoint is a long-type variable which supplies the transmission end position adjusted by the transmission position adjustment unit 1704 described later. In the case where the adjustment of the transmission end position is not requested, the member variable adjustEndPoint supplies the same position as that with the member variable requestEndPoint.

A method setNetDevice( ) in FIG. 28(6) sets a NetDevice instance provided by the argument dev, as information on the device to be included in the reply message. It returns 0 when successful and returns an error code which is a non-0 value in the case of failure.

A method setContentURI( ) in FIG. 28(7) sets a character string provided by a String argument uri, as the content URI to be included in the reply message. It returns 0 when successful and returns an error code which is a non-0 value in the case of failure.

A method setResponseContentRange( ) in FIG. 28(8) sets a ContentRange instance provided by the argument range, as the range of transmitted data to be included in the reply message. It returns 0 when successful and returns an error code which is a non-0 value in the case of failure. In the case where the argument range is null, it is assumed a range designation was not made in the transmission request from the client.

A method createHttpResponse( ) in FIG. 28(9) generates the header of an HTTP response to be sent back, according to the response code of the HTTP provided by an argument rcode and an extension header provided by an argument headers, and returns this using an array of a String variable. The method createHttpResponse( ) returns null in the case of failure. In this method, the information set by the aforementioned methods setNetDevice( ), setContentURI( ), and setResponseContentRange( ) are used. Here, the HTTP response header according to the argument range provided by the setResponseContentRange( ) shall be described. In the case where the argument range is null, since the entire multimedia data is to be transmitted, a Content-Length header is generated with the file size of the multimedia data as a value. The file size of the multimedia data may be obtained by requesting the IO 405g, and may also be provided by providing a other method. Furthermore, in the case where the member variables startPointAdjust and endPointAdjust of the argument range are both false, the Content-Length header and ContentRange header are generated using the values of the member variables requestStartPoint and requestEndPoint of the argument range. Next, in the case when either one of the member variables startPointAdjust and endPointAdjust of the argument range is true, the Content-Length header is generated from the values of the member variables adjustStartPoint and adjustEndPoint of the argument range. Furthermore, X-Content-Range-Adjust is generated from the values of the member variables requestStartPoint and requestEndPoint of the argument range. Furthermore, although there are cases where only the transmission start position is designated and the transmission end position is not designated, in such a case, the transmission end position is assumed to be the ending point of the multimedia data. In this case, although the file size becomes necessary when obtaining the above-mentioned header, the file size may be obtained by requesting the IO 405g, and may also be provided by providing a other method. Alternatively, the file size may be described in attribute information.

The transmission position adjustment unit 1704 adjusts the transmission start position and the transmission end position to the encryption block.

The transmission position adjustment unit 1704 provides Java API to the control unit 1701 and the downloaded Java application. FIG. 30 is an example of the Java API provided by the transmission position adjustment unit 1704. A method adjustPosition( ) in FIG. 30(1) performs the adjustment of the transmission start position and the transmission end position based on the details of the ContentRange instance provided by the argument range, and sets the adjusted values in the member variables adjustStartPoint and adjustEndPoint of the argument range. It returns 0 when successful, and returns an error code which is a non-0 value. In the case where the argument range is null, 0 is returned. When the present method is called, the network library 405e first checks the value of the member variable startPointAdjust of the argument range and, when this is false, sets in the member variable adjustStartPoint of the argument range, the value of the member variable requestStartPoint of the argument range. When the startPointAdjust is true, the network library 405e sets, in the adjustStartPoint, the value of the starting point of the encryption block which includes the value of the requestStartPoint. The network library 405e checks the value of the member variable endPointAdjust of the argument range and, when this is false, sets in the member variable adjustEndPoint of the argument range, the value of the member variable requestEndPoint of the argument range. When the endPointAdjust is true, the network library 405e sets, in the adjustEndPoint, the value of the ending point of the encryption block which includes the value of the requestEndPoint. When the above-described process ends normally, a return value of 0 is returned and, when any error occurs, an error code is returned. Note that although in the present embodiment the transmission start position is adjusted to the starting point of the encryption block which includes the transmission start requested position, as the transmission start position adjustment, it is also possible to adjust to the starting point of an encryption block ahead of the transmission start requested position. Although the transmission end position is adjusted to the ending point of the encryption block which includes the transmission end requested position, as the transmission end position adjustment, it is also possible to adjust to the ending point of an encryption block behind the transmission end requested position.

The transmitting and receiving unit 1705 controls the network unit 211 through the NET 401b4 inside the library 401b of the OS 401, and carries out the transmission and reception of messages between a specified external device connected to the network 103.

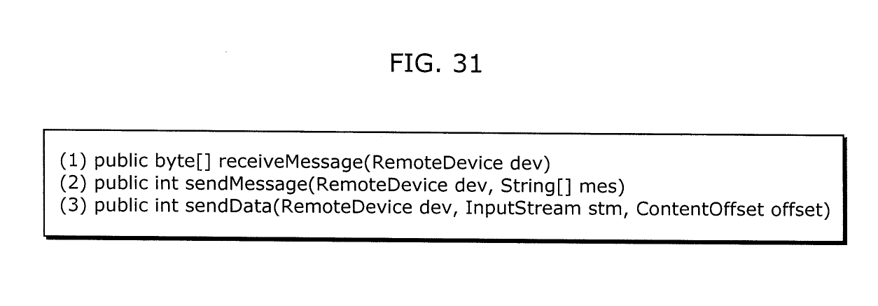

The transmitting and receiving unit 1705 provides Java API to the control unit 1701 and the downloaded Java application. FIG. 31 is an example of the Java API provided by the transmitting and receiving unit 1705. A method receiveMessage( ) in FIG. 31(1) receives a message from a device provided by the argument dev, using a Socket object included in the argument dev, and returns this as an array of byte data. It returns the byte sequence when successful, and returns null in the case of failure.

A method sendMessage( ) in FIG. 31(2) sends a message provided by the argument mes to the device provided by the argument dev. The method sendMessage( ) returns 0 when successful, and returns a non-0 error code in the case of failure.

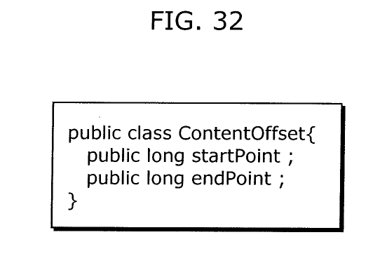

A method sendData( ) in FIG. 31(3) reads the data of the range provided by the argument offset, from the InputStream instance provided by the argument stm, and at the same time transmits the read data to the device provided by the argument dev. It returns 0 when successful and returns a non-0 error code in the case of failure. Failure refers to, for example, the case where network connection is closed during the transmission, the case where the InputStream is closed during reading, the value of offset is incorrect, and the like. The argument offset is provided by the instance of a ContentOffset class. FIG. 32 shows an example of the ContentOffset class. In FIG. 32, a member variable startPoint indicates the start position of transmission, and a member variable endPoint indicates the end position at which the transmission is ended. Here, the start position and end position are indicated by byte positions with the beginning of the multimedia data being 0. Note that in the case where the argument offset is null, or in the case where the member variable startPoint of the offset is 0 and the value of the member variable endpoint is a negative value, all the data read from the InputStream instance provided by the argument stm is returned.

Here, details of the operation of the method actMultimediaServer( ) of the control unit 1701 shall be described. When the present method is called, the network library 405e first calls the collectDevice( ) and carries out recognition of a device connected to the network. Furthermore, the network library 405e generates a Socket object and goes on standby for a communication defined in the UPnP DA or UPnP AV. These are performed on the other thread or process which is newly generated. With this, communication defined in the UPnP DA is performed and the list of connected devices is updated as necessary. Furthermore, when a content list transmit request via the network 103 is received, communication defined in the UPnP AV is performed, and a list of contents that can be provided is transmitted.

Furthermore, by calling the method acceptConnection( ) of the connection management unit 1702, the network library 405e awaits for a connection establishment request for multimedia data communication via the network 103.

Furthermore, when the registerHandler( ) of the control unit 1701 is called by the Java application, the network library 405e performs the setting of a call back handler, as necessary.

When notified of the acceptance of the connection from a device connected to the network, through the method acceptConnection( ) of the connection management unit 1702, the network library 405e receives a RemoteDevice instance rdev which is information on the communication-partner device. Furthermore, the network library 405e then receives a request message using the method receiveMessage( ) of the transmitting and receiving unit 1705. In addition, the network library 405e provides the received message to the message processing unit 1703, and causes it to perform analysis through the method parseMessage( ). Furthermore, network library 405e obtains the type of the request message through the method getRequestType( ).

In the case where the received request message is an HTTP-GET for a content, that is, a transmission request for content data, the network library 405e calls the method getContentURI( ) of the message processing unit 1703 and obtains the URI of the content. Next, the network library 405e reads the URI table 1331 by requesting the IO 405g and, by comparing with the content URI, obtains the identifier of the requested content. Next, the network library 405e reads the attribute information table 1321 by requesting the IO 405g, and obtains the file name of the attribute information file of the content for the identifier. Next, the network library 405e reads the attribute information file of the file name by requesting the IO 405g, and obtains the file name of the content. Next, the network library 405e obtains an InputStream instance which reads the content data of the file name, by requesting the IO 405g.

In addition, the network library 405e calls the method getRequestContentRange( ) of the message processing unit 1703, and obtains a ContentRange instance range indicating the information on the transmission position designation. Furthermore, in the case where there is no position designation, the range becomes null, as described earlier.

In addition, the network library 405e calls the method adjustPosition( ) of the transmission position adjustment unit 1704 and, by providing range as the argument, performs position adjustment in the case where the adjustment of the transmission start position and the transmission end position is requested by the client.

In addition, the network library 405e sets the information of the multimedia data transmitting apparatus 101 into the method setNetDevice( ) of the message processing unit 1703. Furthermore, the network library 405e provides and sets the URI of the content to be sent back, into the method setContentURI( ) of the message processing unit 1703. In addition, the network library 405e calls the method setResponseContentRange( ) of the message processing unit 1703, provides range as the argument, and sets the range of the data to be transmitted. In addition, when there is an HTTP extension header necessary for replying, the network library 405e: generates such extension header; provides 200 indicating OK, as an HTTP response code, as well as the generated extension header to the method createHttpResponse( ) of the message processing unit 1703; and generates the header of the HTTP response message.

Next, the network library 405e provides, to the method sendMessage( ) of the transmitting and receiving unit 1705, the header of the HTTP response message generated by the message processing unit 1703 and rdev, and transmits the header.

In addition, the network library 405e obtains an InputStream instance stm which reads the multimedia data obtained from the IO 405g.

Furthermore, in the case where range is null, the network library 405e generates a ContentOffset instance offset and sets, in the member variable startPoint thereof, the value of the member variable adjustStartPoint of the range, and sets, in the member variable endpoint, the value of the member variable adjustEndPoint of the range. In the case where range is null, offset is also null.

In addition, the network library 405e calls the method sendData( ) of the transmitting and receiving unit 1705, provides rdev, stm, offset as arguments, and causes it to transmit the multimedia data.

As described in the processes of the respective methods, even when there is no transmission range designation from the client, processing can be carried out in the same procedure by making null the range and the offset.

Note that in the case where trouble occurs, such as when the content of the requested URI does not exist, the network library 405e causes the message processing unit 1703 to generate an error message in accordance with such trouble, and transmits this through the method sendMessage( ) of the transmitting and receiving unit 1705.

Next, the multimedia data receiving apparatus 102 shall be described.

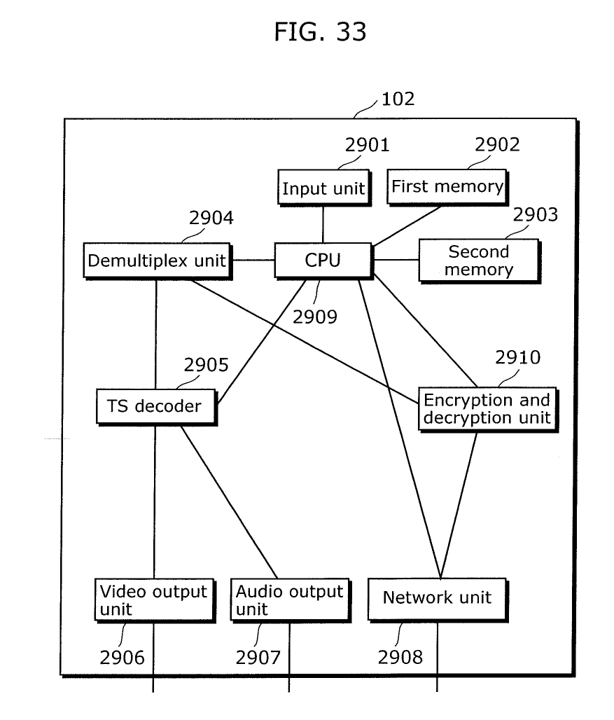

FIG. 33 is a block diagram showing the relationship of constituent elements of the multimedia data receiving apparatus 102 in the present embodiment. The multimedia data receiving apparatus 102 includes an input unit 2901, a first memory 2902, a second memory 2903, a demultiplex unit 2904, a TS decoder 2905, a video output unit 2906, an audio output unit 2907, a network unit 2908, a CPU 2909, and an encryption and decryption unit 2910.

Note that the functions of the Java execution unit 4201, the request message generation unit 4202, and the data processing unit 4206 are implemented through the execution, by the CPU 2909, of a program stored in the second memory 2903. The functions of the message transmitting unit 4203 and the data receiving unit 4204 are implemented through the execution, by the network unit 2908 and the CPU 2909, of a program stored in the second memory 2903. The function of the decryption unit 4205 is implemented through the execution, by the encryption and decryption unit 2901 and the CPU 2909, of a program stored in the second memory 2903. The function of the reproduction unit 4207 is implemented through the execution, by demultiplex unit 2904, the TS decoder 2905, and the CPU 2909, of a program stored in the second memory 2903.

The input unit 2901, the first memory 2902, and the second memory 2903 are identical to the input unit 201, the first memory 202, and the second memory 203 of the previously described multimedia data transmitting apparatus 101 in the present embodiment. Note that the multimedia data receiving apparatus 102 stores, in the second memory 2903, TV-program information such as the identifier, title, broadcast date and time, broadcast channel, and so on, of the multimedia data in the content list, EPG data, and so on, received from the multimedia data transmitting apparatus 101.

The demultiplex unit 2904 receives an MPEG transport stream from the CPU 2909, extracts information specified by the CPU 2902 and passes the extracted information to the CPU 2902. In addition, demultiplex unit 2904 passes the MPEG transport stream directly to the TS decoder 2905.

The TS decoder 2905 receives identifiers of audio data, video data from the CPU 2902. In addition, the TS decoder 2905 extracts data corresponding to the received identifiers of audio data and video data, from the stream received from the demultiplex unit 2904. The TS decoder 2905 passes extracted video data to the video output unit 2906, and audio data to the audio output unit 2907.

The video output unit 2906 and the audio output unit 2907 are identical to the video output unit 208 and the audio output unit 209, respectively, of the previously described multimedia data transmitting apparatus 101 in the present embodiment.

The network unit 2908, which includes a network interface, converts the data received from the CPU 2902 into a signal that is in accordance with the physical media of the network to which the network interface is connected to, and outputs this signal. Furthermore, the network unit 2908 receives a signal from the network interface, converts the signal into a packet defined by the IP network, and passes the packet to the CPU 2902.

The CPU 2909 controls the demultiplex unit 2904, the TS decoder 2905, the network unit 2908, and the encryption and decryption unit 2910 by executing a program stored in the second memory 2903.

The encryption and decryption unit 2910 performs the encryption of inputted data, and the decryption of inputted encrypted data. The key used in encryption is passed on to the encryption and decryption unit 2910 by a secure method such as SAC. Furthermore, there are cases where the inputted data is received from the CPU 2902 and cases where the inputted data is received from the network unit 2908. In the case of the latter, this is controlled by the CPU 2902.

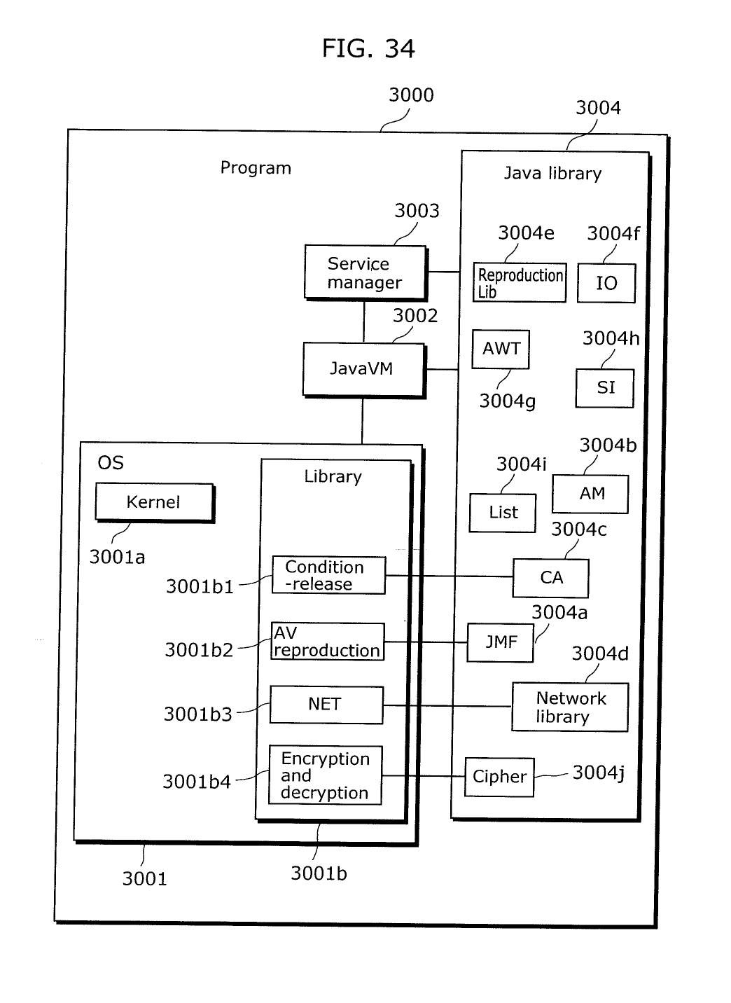

FIG. 34 is an example of a structure diagram of the program stored in the second memory 2903 and executed by the CPU 2909.

A program 3000 is made up of a plurality of subprograms and specifically includes an OS 3001, a Java VM 3002, a service manager 3003, and a Java library 3004.

The OS 3001 is a subprogram activated by the CPU 2902 when power to the multimedia data receiving apparatus 102 is turned on. OS stands for operating system, an example of which is Linux and the like. The OS 3001 is a generic name for publicly known technology made up of a kernel 3001a for executing another subprogram concurrently, and of a library 3001b, and therefore detailed description is omitted. In the present embodiment, the kernel 3001a of the OS 3001 executes the Java VM 3002 as a subprogram. Furthermore, the library 3001b provides these subprograms with plural functions for controlling the constituent elements held by the multimedia data receiving apparatus 102.

In the present embodiment, the library 3001b includes condition-release 3001b1, AV reproduction 3001b2, NET 3001b3, and encryption and decryption 3001b4 as an example of functions.

The condition-release 3001b1 receives information from other subprograms or a CA 3004c of the Java library 3004, enables the AV reproduction 3001b2, and permits the reproduction of the multimedia data received from the network.

The AV reproduction 3001b2 receives an audio packet ID and video packet ID from the other subprograms or a JMF 3004a of the Java library 3004. It then provides the received audio packet ID and video packet ID to the TS decoder 2905. As a result, the TS decoder 2905 performs filtering based on the provided packet IDs, and implements the reproduction of audio/video.

The NET 3001b3 creates packets of a protocol lower than the application layer defined in the IP network, for the data received from the other subprograms or a network library 3004d of the Java library 3004. A protocol lower than the application layer refers to, for example, a TCP packet, a UDP packet, an IP packet, and so on. By passing this to the network unit 2908, messages and data are transmitted to another device via the network 103. Furthermore, when a message is received from another device via the network 103, the NET 3001b3 converts the message to an application layer protocol packet and passes this to the other subprograms or the network library 3004d of the Java library 3004. An application layer protocol refers to, for example, HTTP, RTSP, RTP, and so on.

The encryption and decryption 3001b4 receives information from other subprograms or a Cipher 3004j of the Java library 405, and passes this to the encryption and decryption unit 2910. With this, the encryption and decryption unit 2910 receives data, and performs the encryption or decryption of the received data.

The Java VM 3002 is identical to the Java VM 403 of the previously described multimedia data transmitting apparatus 101 in the present embodiment.

The service manager 3003 is identical to the service manager 404 of the previously described multimedia data transmitting apparatus 101 in the present embodiment except for the following points of difference. The service manager 404 receives a channel identifier from the reproduction unit 402b of the EPG 402; passes the identifier to the Tuner 405c and causes the Tuner 405c to perform tuning; performs descrambling by requesting the CA 405d; and requests the reproduction of video and audio by providing the channel identifier to the JMF 405a. Whereas, the service manager 3003 receives the content identifier from a List 3004i inside the Java library 3004; passes the content identifier as well as information on the apparatus storing such content identifier, and so on, to the network library 3004d and receives a stream from the apparatus; then requests for the reproduction of video and audio by providing the content identifier to the JMF 3004a inside the Java library 3004. The List 3004i shall be described later.

The service manager 3003 provides, to the network library 3004d inside the Java library 3004, information such as the content identifier and the IP address of multimedia data transmitting apparatus 101, and information such as the URI for accessing the content; requests the multimedia data transmitting apparatus 101 for the issuance of a multimedia data transmission request and the reception of the multimedia; and in addition requests the network library 3004d to receive the multimedia data transmitted from the multimedia data transmitting apparatus 101. Upon receiving the request, the network library 3004d connects to the multimedia data transmitting apparatus 101, and issues a transmission request for the multimedia data. Subsequently, the network library 3004d passes the data transmitted by the multimedia data transmitting apparatus 101, to the CPU 2902.

The service manager 3003, in addition, passes the data requested to and received from the Cipher 3004j inside the Java library 3004, to the encryption and decryption unit 2910, and causes it to decrypt the cryptography. With this, it is possible to pass the decrypted multimedia data to the demultiplex unit 2904 and carry out the reproduction of the multimedia data.

Note that the passing of the encrypted data to the encryption and decryption unit 2910 may be performed via the CPU 2902, and may also be inputted directly from the network unit 2908 to the encryption and decryption unit 2910. Furthermore, in the case where the encryption and decryption unit 2910 passes the decrypted data to the demultiplex unit 2904, the decrypted data may be passed via the CPU 2902 using a method that can conceal information, or the decrypted data may be passed directly from the encryption and decryption unit 2910 to the demultiplex unit 2904.

Note that with regard to trick play such as fast forward, rewind, and so on, the service manager 3003 requests trick play to the JMF 3004a described later, and in addition, performs trick play by requesting the network library 3004d to sequentially receive data necessary for trick play.

The Java library 3004 is a collection of plural Java libraries stored in the second memory 2903. In the present embodiment, the Java library 3004 includes the JMF 3004a, an AM 3004b, the CA 3004c, the network library 3004d, a reproduction Lib 3004e, the List 3004i, and so on.

The JMF 3004a, the AM 3004b, the reproduction Lib 3004e, an IO 3004f, an AWT 3004g, a SI 3004h are identical to the JMF 405a, the AM 405b, the reproduction Lib 405f, the IO 405g, the AWT 405h, and the SI 405i, respectively, which are located inside the Java library 405 of the previously described multimedia data transmitting apparatus 101 in the present embodiment.

The CA 3004c manages rights processing of the multimedia data, such as the copy control for the multimedia data transmitted via the network 103. Information for copy control may be transmitted from content providers such as the multimedia data transmitting apparatus 101 and the broadcast station 105, and an external server specified by the rights holder, and may also be referred to from copy control information included in the PMT of a transport stream transmitted from a multimedia data transmitting apparatus.

The List 3004i displays an EPG of the multimedia data transmitting apparatus 101 or a list of multimedia contents stored and provided by the multimedia data transmitting apparatus 101, selects one multimedia content from the list according to a user's operation accepted by the input unit 2901, and requests reproduction to the service manager 3003. At this time, information on the multimedia data transmitting apparatus 101 is also passed to the service manager 3003. Furthermore, the EPG of the multimedia data transmitting apparatus 101 and the list of contents to be provided from the multimedia data transmitting apparatus 101 can be obtained through the network library 3004d. Note that the List 3004i may also be included in the network library 3004d.

The Cipher 3004j provides, via the encryption and decryption 3001b4 inside the library 3001b of the OS 3001, Java API for controlling the encryption and decryption unit 2910. Using this Java API, the encryption and decryption unit 2910 can be made to perform the encryption or decryption of data.

The network library 3004d communicates with the multimedia data transmitting apparatus 101 connected to the network 103, through the NET 3001b3 of the OS 3001. The communication with the multimedia data transmitting apparatus 101 includes multimedia data list transmission/reception, multimedia data transmission request issuance and reception of the multimedia data.

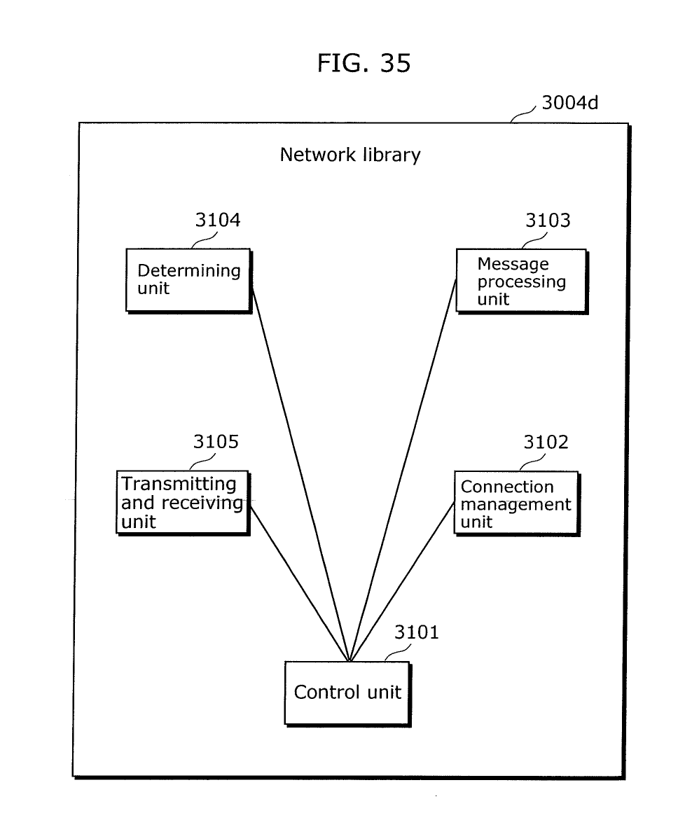

FIG. 35 is a block diagram showing an example of the internal configuration of the network library 3004d. The network library 3004d includes a control unit 3101, a connection management unit 3102, a message processing unit 3103, a determining unit 3104, and a transmitting and receiving unit 3105. Note that the network library 3004d may also include other functions related to the IP network.

The control unit 3101 provides, to a downloaded Java application, the function for implementing the network library 3004d. In other words, the control unit 3101 can execute a network-using function by providing Java API to the downloaded Java application, and by the Java application calling such API. When the Java API is called, the control unit 3101 performs processes using the connection management unit 3102, the determining unit 3104, the transmitting and receiving unit 3105, and the rest of the Java library 3004 and the library 3001b of the OS 3001, as necessary.

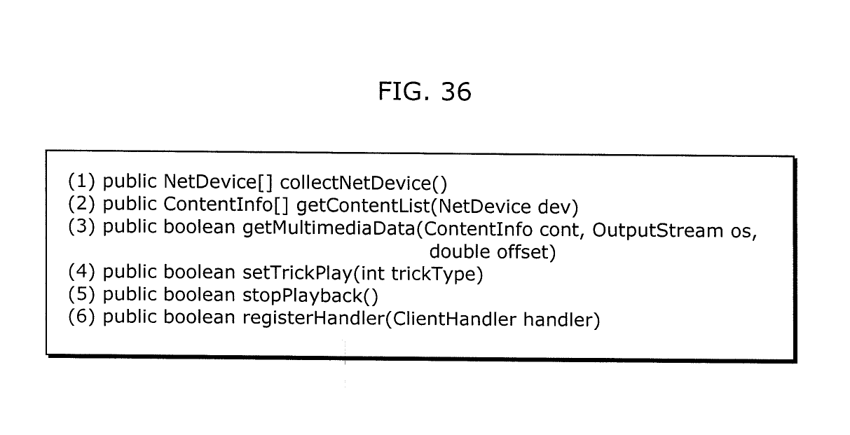

FIG. 36 is an example of the Java API provided by the control unit 3101. A method collectDevice( ) in FIG. 36(1) collects information on other devices connected to the network 103, and returns, as such information, the array of NetDevice objects. It returns null in the case of failure. With this method, it is possible to obtain information on the device connected to the network 103. The NetDevice class is identical to that shown in FIG. 23. Since the process for this method can be carried out according to the method defined in UPnP DA, detailed description shall be omitted.

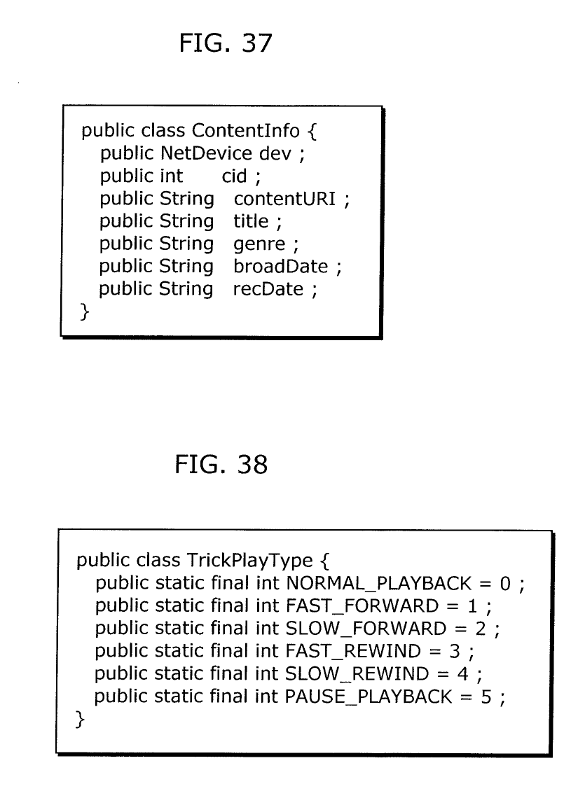

A method getContentList in FIG. 36(2) obtains a list of contents from a multimedia server provided by the argument dev and connected to the network 103. When successful, the method getContentList returns the content list using an array of instances of a ContentInfo class, and returns null in the case of failure. The argument dev is an array of NetDevice instances, and the setting of plural multimedia servers is possible. In the case where the argument dev is null, the network library 3004d obtains a content list from all multimedia servers connected to the network 103. FIG. 37 shows an example of the ContentInfo class. In FIG. 37, the ContentInfo class is made up of seven member variables. A member variable dev is an instance of the NetDEvice class and indicates the multimedia server providing the content. A member variable cid indicates the identifier of the content. A member variable contentURI indicates the URI for obtaining multimedia data of the content. A member variable title indicates the title of the content. In the case where there is no title, the member variable title is set to null. A member variable genre indicates the genre of the content. This is set to null in the case where the genre is not specified. A member variable broadDate indicates the date and time the content is broadcast. A member variable recDate indicates the date and time the content is recorded.

A method getMultimediaData( ) in FIG. 36(3) receives the multimedia data provided by the argument cont, from the position provided by the argument offset, and outputs this to an OutputStream object provided by the argument os. It returns true when successful and returns false in the case of failure. The argument os performs the role of passing received multimedia data to the encryption and decryption unit 2910. The argument offset provides a position in a content with the beginning as 0. Furthermore, in the case where the starting point is not specified, a value of 0 or less is provided for the argument offset. The content position may be a byte position of the content data, and may also be a unit of time such as seconds. Note that in the present embodiment, although only the starting point is provided by an argument, it is also possible to add an argument and likewise provide the temporal position of the ending point. In this case, when the ending point is not specified, it may be implemented by providing a negative number for the argument. The argument cont is provided as an object of the ContentInfo class.

A method setTrickPlay( ) in FIG. 36(4) is equivalent to the changing of playback which is currently in progress to the trick play indicated by the argument trickType, and changes the data communication currently in progress in accordance with the type of the playback. The value adopted by the argument trickType is defined by the TrickPlayType class. FIG. 38 shows an example of the TrickPlayType class. In FIG. 38, the TrickPlayType is made up of six constants. A NORMAL_PLAYBACK is the member variable which is fixed to 0, and which indicates normal playback. Furthermore, FAST_FORWARD is the member variable which is fixed to 1, and which indicates fast forward playback. Furthermore, SLOW_FORWARD is the member variable which is fixed to 2, and which indicates slow playback. Furthermore, FAST_REWIND is the member variable which is fixed to 3, and which indicates reverse playback. Furthermore, SLOW_REWIND is the member variable which is fixed to 4, and which indicates reverse slow playback. Furthermore, PAUSE_PLAYBACK is the member variable which is fixed to 5, and which indicates a pause in the playback. A method setTrickPlay( ) is provided with the above member variables as arguments. With this, the network library 3004d determines the range of the data needed in the trick play or normal play that are switched by the determining unit 3104 described later, and obtains the data from the multimedia data transmitting apparatus 101. Note that it goes without saying that the types of the trick play are not limited to the above. For example, skip playback in which playback is restarted after being skipped for a fixed time can be processed in the same manner. Furthermore, the speed for fast forward and reverse, slow, and the like, may be made switchable to different levels.

A method stopPlayback( ) in FIG. 36(5) is equivalent to the stopping of the playback which is currently in progress. It stops the data communication currently in progress, and cuts-off the network session. The method stopPlayback( ) returns true when successful and returns false in the case of failure.

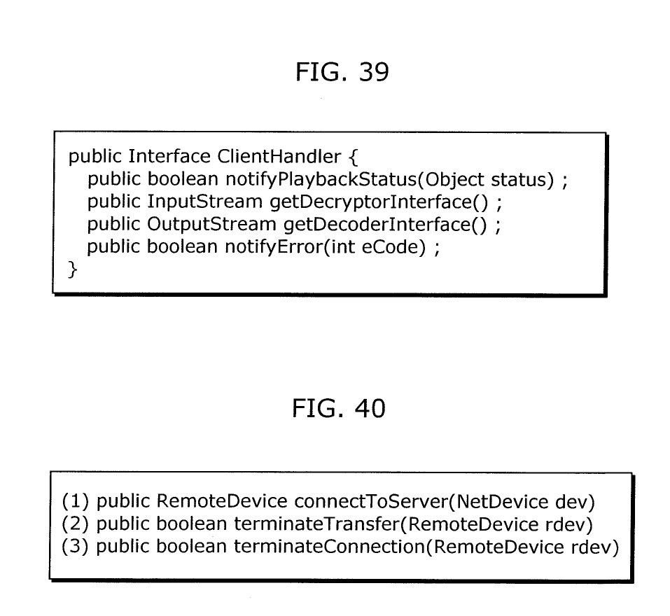

A method registerHandler( ) in FIG. 36(6) registers, into the system, a ClientHandler interface-equipped object which is provided through an argument handler. It returns true when successful and false in the case of a failure. By registering the object as a handler, the Java application can receive a callback from the network library 3004d. FIG. 39 shows an example of the structure of the ClientHandler interface. In FIG. 39, a method notifyPlaybackStatus( ) of the ClientHandler notifies the Java application of the status of the communication for the playback which is currently in progress. The communication status refers to, for example, the number of cumulative data, the amount of data per unit of time, and so on. Furthermore, a method getDecryptorInterface( ) obtains an InputStream instance for receiving data from the encryption and decryption unit 2910, by requesting an application, the service manager 3003, and so on. Through the InputStream instance which is the return value of this method, it becomes possible to obtain the data decrypted by the encryption and decryption unit 2910. Furthermore, the method getDecoderInterface( ) obtains an OutputStream interface which outputs data to the demultiplex unit 2904, by requesting an application, the service manager 3003, and so on. Furthermore, a method notifyError( ) notifies the occurrence of an error to the Java application, using an error code provided by an argument eCode. By being notified of the error, the Java application can present the error to the user.

The connection management unit 3102 manages the network session, between a multimedia server, for communicating multimedia data.

The connection management unit 3102 provides Java API to the network library 3004d and the downloaded Java application. FIG. 40 is an example of the Java API provided by the connection management unit 3102. A method connectToServer( ) in FIG. 40(1) creates a Socket object s; establishes a TCP session with the device provided by the argument dev using the Socket object s; generates a RemoteDevice object using the Socket object s and the details of the argument dev and returns it. The method connectToServer( ) returns the RemoteDevice object when successful, and returns null in the case of failure. The structure of the RemoteDevice class is identical to that shown in FIG. 27. Communication of messages and multimedia data is carried out in this TCP session.

A method terminateTransfer( ) in FIG. 40(2) terminates the communication with the server provided by the argument rdev. It returns true when successful and returns false in the case of failure. In this method, although the communication is ended, the TCP connection is not closed.

Furthermore, a method terminateConnection( ) in FIG. 40(3) closes the network connection with the server provided by the argument rdev. This method is implemented by closing the Socket object indicated by the member variable s of the argument rdev. With this method, even during data communication, such communication is closed.

The message processing unit 3103 generates a request message to be transmitted via the network 103, and analyzes a reply message.

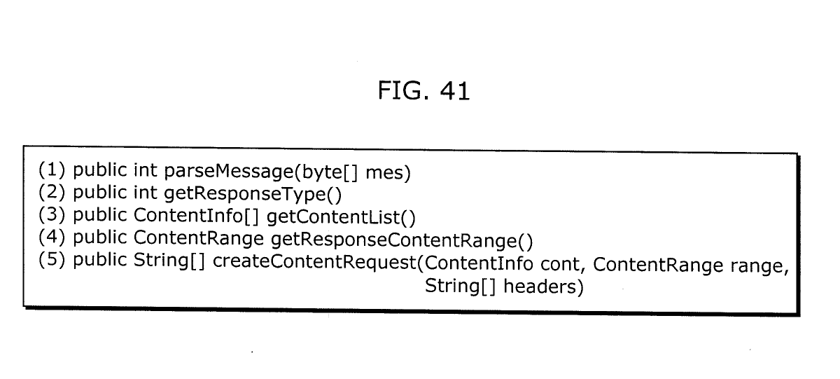

The message processing unit 3103 provides Java API to the control unit 3101 and the downloaded Java application. FIG. 41 is an example of the Java API provided by the message processing unit 3103. A method parseMessage( ) in FIG. 41(1) analyzes a received message provided by an argument mes which is a byte-type array. The method parseMessage( ) returns 0 when successful, and returns a non-0 error code in the case of failure. Data provided by the argument mes is data received by the transmitting and receiving unit 3105 to be described later. In the case where the message is a content list, method parseMessage( ) interprets the content list, generates an array of ContentInfo instances and stores the content list therein.

A method getResponseType( ) in FIG. 41(2) returns the type of a successfully interpreted received message. It returns a positive value representing the type when successful, and returns a negative value error code in the case of failure. In the present embodiment, 1 is returned in the case where the received message is a content list, and in the case of an HTTP response header, a response code thereof is returned.

A method getContentInfo( ) in FIG. 41(3) returns an array of the ContentInfo instances generated from the interpreted content list. It returns null when the content could not be read or in the case of failure.

A method getResponseContentRange( ) in FIG. 41 (4) returns a ContentRange instance indicating the range of data to be transmitted based on the successfully interpreted received message. It returns null in the case of failure or when there is no range designation. The ContentRange class is identical to that shown in FIG. 29.

A method createConentRequest( ) in FIG. 41(5) generates a transmission request message for the section indicated by the argument range, within the multimedia data of the content provided by the argument cont, for the multimedia server provided by the argument dev. The method createConentRequest( ) returns the generated message using an array of String variables, and returns null in the case of failure. Since HTTP is used as the content transmission protocol, the generated message is the HTTP-GET message. The multimedia server to which the request is to be sent can be obtained from the member variable dev of the argument cont. Furthermore, the URI of the requested content can be obtained from the member variable content URI of the argument cont. Information such as section for which transmission is requested, and whether or not adjustment of the transmission start position and the transmission end position is requested, is obtained from the argument range. The transmission start requested position is set in the member variable requestStartPoint of the range. In the case where transmission from the beginning of the multimedia data is requested, the requestStartPoint is set to 0. Furthermore, the transmission end requested position is set in the member variable requestEndPoint of the range. In the case where transmission up to the end of the multimedia data is requested, the requestEndPoint is set to a negative value. Furthermore, in the case of requesting adjustment of the transmission start position, true is set to the member variable startPointAdjust of the range; and in the case where the adjustment of the transmission start position is not requested, false is set to the startPointAdjust. Furthermore, in the case where adjustment of the transmission start position is requested, true is set to the member variable startPointAdjust of the range; and in the case where the adjustment of the transmission start position is not requested, false is set to the startPointAdjust. Furthermore, in the case of sending a transmission request for the entire multimedia data without designating a section, a value of null is provided to the argument offset. The transmission start position and the transmission end position are indicated by byte positions with the beginning of the multimedia data being 0. Furthermore, the argument headers provides, in the case where there is an extension header to be added, such extension header. Depending on the value of the argument range, the network library 3004d configures the request message using an HTTP Range header, the above-described X-Range-Adjust header, or the like.

The determining unit 3104 determines the next necessary data section for trick play. The determining unit 3104 may obtain the necessary data section from the service manager 3003, the JMF 3004a, and the like, and the determining unit 3104 itself may make the judgment. In the case where the determining unit 3104 itself makes the determination, it may calculate using information such as the bit rate of the multimedia data, and it may also obtain, in advance, information of the byte position and size of a GOP and an I frame, and so on, from the multimedia data transmitting apparatus 101, and the like, and make the determination by referring to such information. The determining unit 3104 determines a data section necessary for playback, however the unit of encryption is not taken into consideration during such time.

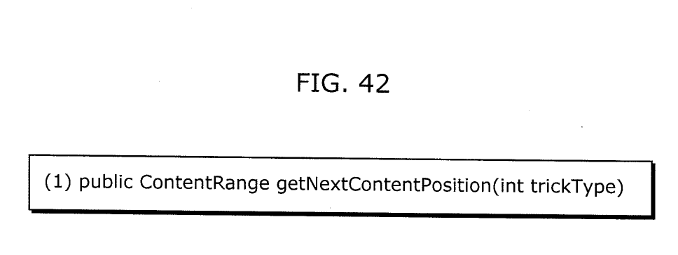

The determining unit 3104 provides Java API to the network library 3004d and the downloaded Java application. FIG. 42 is an example of the Java API provided by the determining unit 3104. A method getNextContentPosition in FIG. 42(1) determines, in the case where the playback of the type provided by the argument trickType is to be performed, the range of data that should be obtained next and returns this through a ContentRange instance. It returns null in the case of failure.

The transmitting and receiving unit 3105 controls the network unit 2908 through the NET 3001b3 of the library 3001b of the OS 3001, and performs the connection with the specified external device connected to the network 103 as well as the transmission and reception of messages and data.

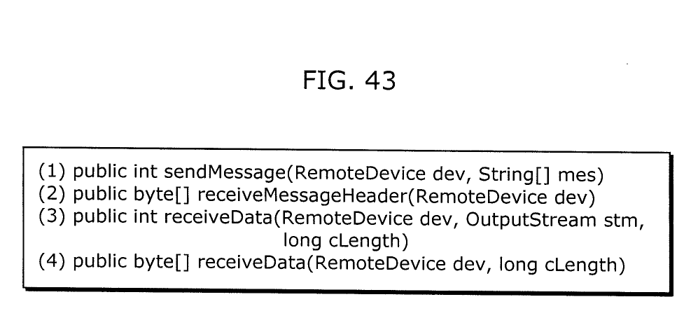

The transmitting and receiving unit 3105 provides Java API to the network library 3004d and the downloaded Java application. FIG. 43 is an example of the Java API provided by the transmitting and receiving unit 3105. A method sendMessage( ) in FIG.43(1) transmits data provided by the argument mes to the external device provided by the argument dev, using the Socket object that can be obtained from the argument dev. The method sendMessage( ) returns true when successful, and returns false in the case of failure.

A method receiveMessageHeader( ) in FIG. 43(2) receives, using a Socket object that can be obtained from the argument dev, the header of the message sent from a device provided by the argument dev, and returns the received data through a byte sequence. It returns null in the case of failure.

A method receiveData( ) in FIG. 43(3) receives, using a Socket object that can be obtained from the argument dev, data sent from a device provided by the argument dev and having a length provided by an argument cLength as a maximum length, and outputs the received data to an OutputStream object provided by the argument stm. The method receiveData( ) returns the number of received data when successful and returns a negative integer value, which is an error code, in the case of failure. The received data is not outputted after its entirety is received, but instead sequentially outputted while being received. Failure refers to, for example, the case where TCP connection is closed during the transmission.

A method receiveData( ) in FIG. 43(4) receives, using a Socket object that can be obtained from the argument dev, data sent from a device provided by the argument dev and having a length provided by the argument cLength as a maximum length. It returns the received data as a byte sequence, and returns null in the case of failure. Failure refers to, for example, the case where TCP connection is closed during the transmission.

Here, the operation of the method getMultimediaData( ) of the control unit 3101 shall be described. When this method is called, the network library 3004d receives data from the multimedia data transmitting apparatus 101, as normal playback. First, the network library 3004d obtains information on the content to be played back, from the argument cont. The network library 3004d communicates with the multimedia data transmitting apparatus 101 as necessary, and obtains information of the byte position and size of the GOP and the I frame. In addition, it obtains the position at which to start the playback, from the argument offset. Such information are stored as an internal state of the network library 3004d. Next, the network library 3004d provides an argument TrickPlayType.NORMAL_PLAYBACK to the method getNextContentPosition( ) of the determining unit 3104 and calls it, and obtains a ContentRange instance range indicating the data section that should be obtained next. Such section is determined by referring to the internal state of the network library 3004d. In the case where playback is started, playback is performed from the section provided by the argument offset. Furthermore, the network library 3004d judges whether or not to perform the adjustment of the transmission start position and the transmission end position. Since the adjustment of both the transmission start position and the transmission end position are requested in the case of the first communication, true is set to both the member variables startPointAdjust and endPointAdjust of the range. Next, when there is a necessary extension header, the network library 3004d generates such extension header as a String array. Next, by providing the value of the argument cont, the value of the range, and the array of the String variables generated as the extension header, for the argument, the network library 3004d calls the method createContentRequest( ) of the message processing unit 3103, causes it to generate an HTTP-GET request message which is a content data transmission request, and receives this. Next, by providing the value of member variable dev of the argument cont as an argument, the network library 3004d calls the method connectToServer of the connection management unit 3102, establishes a TCP connection with the multimedia server, and receives the RemoteDevice object as a return value. The received RemoteDevice object is assumed to be rdev. In addition, the network library 3004d calls the method sendMessage( ) of the transmitting and receiving unit 3105 and, by providing, as the argument therefor, rdev and the generated HTTP-GET request message, transmits the content transmission request message to the specified multimedia server. In addition, the network library 3004d calls the method receiveMessageHeader( ) of the transmitting and receiving unit 3105 and, by providing rdev for the argument, receives the header of a reply message from the multimedia server. In addition, the network library 3004d calls the method parseMessage( ) of the message processing unit 3103, by providing the received header to the argument. When analysis is successful, the network library 3004d then calls the method getResponseType( ) of the message processing unit 3103 and obtains an HTTP response code. When the response code is 200 indicating OK, the network library 3004d then calls the method getResponseContentRange( ) of the message processing unit 3103, and obtains crange which is an instance of the ContentRange. In addition, the network library 3004d sets, in the long-type variable cLength, a value resulting from subtracting adjustStartPoint from the member variable adjustEndPoint of the crange and adding 1. Next, by calling the method receiveData in FIG. 43(4) which is a method of the transmitting and receiving unit 3105, with rdev, the argument os, and the value of cLength as arguments, the network library 3004d receives the multimedia data, and performs the playback by inputting the multimedia data to the encryption and decryption unit 2910. During the receiving of the multimedia data, the amount of received data, and so on, is stored and updated as an internal state of the network library 3004d. When there is still multimedia for which transmission is not requested, the network library 3004d calls the method getNextPosition( ) of the determining unit 3104 and repeats the following. However, since the TCP connection is not closed at the end of the previous HTTP session, the already-obtained RemoteDevice object rdev is used, without calling the method connectToServer( ) of the connection management unit 3102.

Next, the operation when the method setTrickPlay( ) of the control unit 3101 is called shall be described. When this method is called, the network library 3004d first calls the method terminateTransfer( ) of the connection management unit 3102, and causes it to terminate the data communication. Alternatively, the network library 3004d may call the method terminateConnection( ) of the connection management 3102 and close the TCP connection once, then call the method connectToServer of the connection management unit 3102 and restart the TCP connection anew. Next, the network library 3004d stores, as an internal state, the argument trickType at the time the setTrickPlay( ) method is called. Next, the network library 3004d checks whether or not the value of the trickType is TrickPlayType.PAUSE_PLAYBACK. In the case where it is TrickPlayType.PAUSE_PLAYBACK, the network library 3004d waits until the setTrickPlay( ) is called next. In the case where it is not TrickPlayType.PAUSE_PLAYBACK, the network library 3004d further calls the callback function getDecryptorInterface( ) and getDecoderInterface( ), and obtains dis and dos, respectively, as return values. Next, the network library 3004d calls the method getNextContentPosition( ) of the determining unit 3104, with the value of the trickType as an argument, and obtains a ContentRange instance range indicating the data section that should be obtained next. In addition, since the adjustment of the transmission start position and the transmission end position are requested, the network library 3004d sets true in both the member variables startPointAdjust and endPointAdjust of the range. Next, when there is some necessary extension headers, the network library 3004d generates such extension header as a String array. Next, by providing the value of the argument cont, the value of the range, and the array of the String variables generated as the extension header, for the argument, the network library 3004d calls the method createContentRequest( ) of the message processing unit 3103, causes it to generate an HTTP-GET request message which is a content data transmission request, and receives this. In addition, the network library 3004d calls the method sendMessage( ) of the transmitting and receiving unit 3105 and, by providing, as the argument therefor, rdev and the generated HTTP-GET request message, transmits the content transmission request message to the specified multimedia server. In addition, the network library 3004d calls the method receiveMessageHeader( ) of the transmitting and receiving unit 3105 and, by providing rdev for the argument, receives the header of a reply message from the multimedia server. In addition, the network library 3004d calls the method parseMessage( ) of the message processing unit 3103, by providing the received header to the argument. When analysis is successful, the network library 3004d then calls the method getResponseType( ) of the message processing unit 3103 and obtains an HTTP response code. When the response code is 200 indicating OK, the network library 3004d then calls the method getResponseContentRange( ) of the message processing unit 3103, and obtains crange which is an instance of the ContentRange. In addition, the network library 3004d sets, in the long-type variable cLength, a value resulting from subtracting adjustStartPoint from the member variable adjustEndPoint of the crange and adding 1. Next, by calling the method receiveData( ) in FIG. 43(4) which is a method of the transmitting and receiving unit 3105, with rdev, and the value of cLength as arguments, the network library 3004d receives the multimedia data. The network library 3004d first outputs the received multimedia data to the OutputStream instance indicated by the argument os, and causes the encryption and decryption unit 2910 to decrypt the received multimedia data. Next, the network library 3004d reads the decrypted data from the InputStream instance dis. In addition, assume that p as the value resulting from the deduction of the adjustStartPosition from the member variable requestStartPosition of the crange, and dl as the value resulting from subtracting the value of the requestStartPosition from the member variable requestEndPosition of the crange and adding 1. By outputting, from among the read data, the data for a dl number of bytes starting from the p-th byte from the beginning, the network library 3004d passes data to the demultiplex unit 2904 and causes it to display the data. Next, the network library 3004d repeats the process from the calling of the method getNextPosition( ) of the determining unit 3104 and continues the trick play.

Note that the same operation as that when the aforementioned method setTrickPlay( ) is called can be carried out even in normal playback. For example, it is possible to obtain data on a GOP basis, and process them in succession. Furthermore, in such case, since duplicated reception occurs when the transmission start position is requested in the receiving of data for the second time onward, it is possible to increase transmission efficiency by connecting with the decrypted data received previously, without requesting the adjustment of the transmission start position.

Next, the operation when the method stopPlayback( ) of the control unit 3101 is called shall be described. When this method is called, the network library 3004d first calls the method terminateTransfer( ) of the connection management unit 3102, and causes it to terminate the ongoing communication of multimedia data between the server. Next, the network library 3004d calls the method terminateConnection( ) of the connection management unit 3102, and terminates the network session established with the server. In addition, by calling the callback function notifyPlaybackStatus( ) if necessary, the network library 3004 notifies the Java application that the communication for the playback has ended, and ends the process. Note that the processing of the method getMultimediaData( ) of the control unit 3101 which is called for the playback before the present method is called, is ended by the calling of the present method. Furthermore, although the network library 3004d calls the method terminateTransfer( ) of the connection management 3102, and then calls the method terminateConnection( ) of the connection management unit 3102, the network library 3004d may call the method terminateConnection( ) without calling the method terminateTransfer( ).

(Other Variations)

Although the present invention is described based on the above-mentioned embodiments, it should be obvious that the present invention is not limited to such above-mentioned embodiments. The present invention also includes such cases as described below.

(1) Although, in the above-described embodiment, HTTP is used as the content data transfer protocol, other protocols, such as RTP/RTSP, may be used.

(2) Although, in the above-described embodiment, only video content in the MPEG2-TS format is described, it goes without saying that the same processing can also be performed on video content in other coding formats and other types of content such as music.

(3) Although, in the above-described embodiment, the multimedia data transmitting apparatus performs the adjustment of the transmission start position and the transmission end position according to a request from a client, it may perform the adjustment of the transmission start position and the transmission end position independently of the client. Furthermore, the adjustment of the transmission start position and the transmission end position may be performed in the case where there is no notification from the client that position adjustment is unnecessary.

(4) Although, in the above-described embodiment, the multimedia data transmitting apparatus uses AES as the method for encrypting multimedia data, other encryption methods such as 3DES are also acceptable. Furthermore, an encryption method using non-fixed-length blocks is also acceptable. The encryption method may be notified to the network library 405e from the Java application.

(5) Although, the X-Range-Adjust extension header is defined and used in the above-described embodiment, it goes without saying that, other formats are also acceptable as long as it is possible to recognize the transmission start position, the transmission end position, and whether or not position adjustment is necessary.

(6) Although, the X-Range-Adjust extension header is defined and used in the above-described embodiment, it goes without saying that, other formats are also acceptable as long as it is possible to recognize the transmission start position, the transmission end position, and to which part in the transmission data the data section requested by the client coincides.

(7) Although, in the above-described embodiment, the multimedia data receiving apparatus 102 transmits a request message including a transmission start requested position and a transmission end requested position to the multimedia data transmitting apparatus 101, it may also transmit a request message including only the transmission start requested position. Furthermore, although the multimedia data transmitting apparatus 101 receives a request message including a transmission start requested position and a transmission end requested position from the multimedia data receiving apparatus 102, it may also receive a request message including only the transmission start requested position. In this case, the multimedia data transmitting apparatus 101 performs processing as when receiving a transmission request for data from the transmission start requested position to the ending, in the data for which transmission is requested.

(8) A part or all of the constituent elements making up each of the above-mentioned apparatuses may be made from one system LSI (Large Scale Integration circuit). The system LSI is a super multi-function LSI that is manufactured by integrating plural components in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(9) A part or all of the constituent elements making up each of the above-mentioned apparatuses may be made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(10) The multimedia data transmitting apparatus and the multimedia data receiving apparatus of the present invention may also be the above-described methods. The present invention may also be a computer program for executing such methods through a computer, or as a digital signal made from the computer program.

Furthermore, the multimedia data transmitting apparatus and the multimedia data receiving apparatus of the present invention may be a computer readable recording medium on which the computer program or the digital signal is recorded, such as a flexible disc, a hard disc, a CD-ROM, an MO, a DVD, a DVD-ROM, a DVD-RAM, a Blu-ray Disc (BD), a semiconductor memory, and so on. Furthermore, the multimedia data transmitting apparatus and the multimedia data receiving apparatus of the present invention may also be the computer program or the digital signal recorded on such recording media.

Furthermore, the multimedia data transmitting apparatus and the multimedia data receiving apparatus of the present invention may also be the computer program or the digital signal transmitted via an electrical communication line, a wireless or wired communication line, a network represented by the internet, a data broadcast, and so on.

Furthermore, the multimedia data transmitting apparatus and the multimedia data receiving apparatus of the present invention may also be a computer system including a microprocessor and a memory, with the memory storing the computer program and the microprocessor operating in accordance with the computer program.

Furthermore, the present invention may also be implemented in another independent computer system by recording the program or digital signal on the recording medium and transferring the recording medium, or by transferring the program or the digital signal via the network, and the like.

(11) Although the multimedia data transmitting apparatus 101 and the multimedia data receiving apparatus 102 make use of Java applications, aside from Java applications, other application programs that can be imported via a broadcast signal may also be used.

(12) It is also possible to combine the above-described embodiment and the aforementioned variations.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The multimedia data transmitting apparatus, the multimedia data receiving apparatus, and the multimedia content communication system configured thereof, of the present invention allows, in the sharing of multimedia content using a home network, the transmission of encrypted data, which is the format in which multimedia data is stored in the server, directly to a client in the case where the multimedia server transmits multimedia data according to a request from the client. Having the remarkable effect of allowing various types of trick play while ensuring the protection of the multimedia data due to having the ability to reliably decrypt cryptography and obtain data that can be played back, the multimedia data transmitting apparatus, the multimedia data receiving apparatus, and the multimedia content communication system configured thereof, of the present invention are useful as a server apparatus, a receiving terminal, a multimedia data communication method, and the like, for multimedia content in a networked environment such as a home network.

What is claimed is:

1. A multimedia data transmitting apparatus which stores encrypted multimedia data representing at least one of video and audio, and transmits the encrypted multimedia data to a terminal, via a network, in response to a request from the terminal, said multimedia data transmitting apparatus comprising:
a message receiving unit operable to receive a request message from the terminal, the request message being a message requesting transmission of multimedia data and including a transmission start requested position and a transmission end requested position;
a transmission position adjustment unit operable to perform at least one of:
a first adjustment process of adjusting a transmission start position to a boundary of a unit of encryption immediately ahead of the transmission start requested position or to a position ahead of the boundary, in the case where the transmission start requested position does not match a boundary of the unit of encryption of the multimedia data; and
a second adjustment process of adjusting a transmission end position to a boundary of the unit of encryption immediately behind the transmission end requested position or to a position behind the boundary, in the case where the transmission end requested position does not match a boundary of the unit of encryption of the multimedia data; and
a data transmitting unit operable to transmit to the terminal:
the multimedia data, from the adjusted transmission start position in the case where the first adjustment process is performed or the transmission start requested position in the case where the first adjustment process is not performed, up to the adjusted transmission end position in the case where the second adjustment process is performed or the transmission end requested position in the case where the second adjustment process is not performed; and
first information indicating the transmission start requested position and the transmission end requested position within the multimedia data.

2. The multimedia data transmitting apparatus according to claim 1,
wherein the request message further includes request information indicating whether or not the terminal is requesting said multimedia data transmitting apparatus for position adjustment, and
said transmission position adjustment unit is operable to perform at least one of the first adjustment process and the second adjustment process in the case where the request information indicates that position adjustment is requested.

3. The multimedia data transmitting apparatus according to claim 1, further comprising
an application execution unit operable to execute an application program,
wherein said transmission position adjustment unit is operable to perform at least one of the first adjustment process and the second adjustment process, in accordance with a condition received from the application program.

4. The multimedia data transmitting apparatus according to claim 3, further comprising
a broadcast signal receiving unit operable to receive a broadcast signal including the multimedia data and the application program.

5. A multimedia data transmitting method used in a multimedia data transmitting apparatus which stores encrypted multimedia data representing at least one of video and audio, and transmits the encrypted multimedia data to a terminal, via a network, in response to a request from the terminal, said multimedia data transmitting method comprising:
a message receiving step of receiving a request message from the terminal, the request message being a message requesting transmission of multimedia data and including a transmission start requested position and a transmission end requested position;
a transmission position adjustment step of performing at least one of:
a first adjustment process of adjusting a transmission start position to a boundary of a unit of encryption immediately ahead of the transmission start requested position or to a position ahead of the boundary, in the case where the transmission start requested position does not match a boundary of the unit of encryption of the multimedia data; and
a second adjustment process of adjusting a transmission end position to a boundary of the unit of encryption immediately behind the transmission end requested position or to a position behind the boundary, in the case where the transmission end requested position does not match a boundary of the unit of encryption of the multimedia data; and
a data transmitting step of transmitting to the terminal:
the multimedia data, from the adjusted transmission start position in the case where the first adjustment process is performed or the transmission start requested position in the case where the first adjustment process is not performed, up to the adjusted transmission end position in the case where the second adjustment process is performed or the transmission end requested position in the case where the second adjustment process is not performed; and
first information indicating the transmission start requested position and the transmission end requested position within the multimedia data.

6. A multimedia data receiving apparatus which receives encrypted multimedia data from a server via a network, said multimedia data receiving apparatus comprising:
a request message generation unit operable to generate a request message which is a message requesting transmission of multimedia data, the request message including request information, a transmission start requested position which is a transmission start position of the multimedia data, and a transmission end requested position which is a transmission end position of the multimedia data;
a transmitting and receiving unit operable to transmit the request message to the server, and to receive, from the server, the multimedia data and first information which indicates the transmission start requested position and the transmission end requested position within the multimedia data;
a decryption unit operable to decrypt the multimedia data received by said transmitting and receiving unit;
a data processing unit operable to extract multimedia data from the transmission start requested position up to the transmission end requested position indicated in the first information, from the multimedia data decrypted by said decryption unit; and
a reproduction unit operable to reproduce the multimedia data extracted by said data processing unit,
wherein the request information is information indicating whether or not at least one of a first adjustment process and a second adjustment process is requested to the server, the first adjustment process adjusting the transmission start position to a boundary of a unit of encryption immediately ahead of the transmission start requested position or to a position ahead of the boundary, in the case where the transmission start requested position does not match a boundary of the unit of encryption of the multimedia data, the second adjustment process adjusting the transmission end position to a boundary of the unit of encryption immediately behind the transmission end requested position or to a position behind the boundary, in the case where the transmission end requested position does not match a boundary of the unit of encryption of the multimedia data.

7. The multimedia data receiving apparatus according to claim 6, further comprising
an application execution unit operable to execute one or more application programs,
wherein at least one of information identifying the server and an identifier of the multimedia data are received from a certain application program from among the one or more application programs.

8. The multimedia data receiving apparatus according to claim 7,
wherein said request message generation unit is operable to generate the request information in accordance with a condition provided by a certain application program from among the one or more application programs.

9. The multimedia data receiving apparatus according to claim 7,
wherein the one or more application programs are imported via a broadcast signal.

10. A multimedia data receiving method used in a multimedia data receiving apparatus which receives encrypted multimedia data from a server via a network, said multimedia data receiving method comprising:
a request message generation step of generating a request message which is a message requesting transmission of multimedia data, the request message including request information, a transmission start requested position which is a transmission start position, and a transmission end requested position which is a transmission end position;
a transmission step of transmitting the request message to the server;
a receiving step of receiving, from the server, the multimedia data and first information which indicates the transmission start requested position and the transmission end requested position within the multimedia data;
a decryption step of decrypting the received multimedia data;
a data processing step of extracting multimedia from the transmission start requested position up to the transmission end requested position indicated in the first information, from the decrypted multimedia data; and
a reproduction step of reproducing the extracted multimedia data,
wherein the request information is information indicating whether or not at least one of a first adjustment process and a second adjustment process is requested to the server, the first adjustment process adjusting the transmission start position to a boundary of a unit of encryption immediately ahead of the transmission start requested position or to a position ahead of the boundary, in the case where the transmission start requested position does not match a boundary of the unit of encryption of the multimedia data, the second adjustment process adjusting the transmission end position to a boundary of the unit of encryption immediately behind the transmission end requested position or to a position behind the boundary, in the case where the transmission end requested position does not match a boundary of the unit of encryption of the multimedia data.
